(19) United States
(12) Patent Application Publication
(10) Pub. No.: US 2024/0312234 A1
(43) Pub. Date: Sep. 19, 2024

(54) INFORMATION PROCESSING DEVICE AND METHOD FOR PROCESSING INFORMATION

(71) Applicant: FRONTEO, Inc., Tokyo (JP)

(72) Inventors: Takaaki ITO, Tokyo (JP); Huunam Nguyen, Tokyo (JP); Keisuke Tomiyasu, Tokyo (JP); Takafumi Seimasa, Tokyo (JP)

(73) Assignee: FRONTEO, Inc., Tokyo (JP)

(21) Appl. No.: 18/605,407

(22) Filed: Mar. 14, 2024

(30) Foreign Application Priority Data
Mar. 15, 2023 (JP) 2023-040722

(51) Int. Cl. G06V 30/416; G06F 40/268; G06V 30/19

(52) U.S. Cl. CPC G06V 30/416; G06F 40/268; G06V 30/19127; G06V 30/1916

(57) ABSTRACT

An information processing device includes: a model obtaining unit configured to obtain a learned model generated by machine learning that includes: determining a weight of a morpheme in a model, in accordance with a feature determined using a result of morphological analysis; and deleting, from input data of the model, the feature corresponding to the morpheme having the weight determined to be smaller than, or equal to, a threshold value; an obtaining unit configured to obtain document data ; a feature determining unit configured to determine the feature to be input to the learned model, in accordance with the result of the morphological analysis; an inference processing unit configured to input the feature to the learned model, to calculate a score indicating a degree of relevance between the document data and an event; and a display control unit configured to perform display control using the score.

### CROSS-REFERENCE TO RELATED APPLICATION

The present application claims priority from Japanese Application JP 2023-040722, the content of which is hereby incorporated by reference into this application.

### BACKGROUND OF THE INVENTION

### 1. Field of the Invention

The present invention relates to an information processing device, and a method for processing information.

### 2. Description of the Related Art

There are conventionally known techniques to process document data, using machine learning. For example, Japanese Unexamined Patent Application Publication No. 2022-148430 discloses a document information extracting system. When determining a feature of a model, the document information extracting system updates a parameter on the basis of an action type or a weight of the feature to be evaluated.

### SUMMARY OF THE INVENTION

In evaluating the feature, the technique disclosed in Japanese Unexamined Patent Application Publication No. 2022-148430 factors in, for example, similarity relationships in accordance with a similar dictionary, but fails to factor in increasing processing speed and diversity of morphemes to be input when monitoring e-mails.

Some aspects of the present disclosure can provide an information processing device and a method for processing information that execute processing of various morphemes at high speed in monitoring document data.

An aspect of the present disclosure relates to an information processing device including: a model obtaining unit that obtains a learned model generated by machine learning that involves: determining a weight of a morpheme in a model that is either a linear model or a generalized linear model, in accordance with a feature determined based on a result of morphological analysis of learning data that is learning document data; and deleting, from input data of the model, the feature corresponding to the morpheme having the weight determined to be smaller than, or equal to, a given threshold value; an obtaining unit that obtains document data including an electronic mail transmitted and received by a monitored person; a feature determining unit that determines the feature to be input to the learned model, in accordance with the result of the morphological analysis of the document data obtained by the obtaining unit; an inference processing unit that inputs the feature, determined by the feature determining unit, to the learned model, in order to calculate a score indicating a degree of relevance between the document data and a given event; and a display control unit that performs display control based on the score of the document data.

Another aspect of the present disclosure relates to a method, for processing information, causing an information processing device to perform processing of: obtaining a learned model generated by machine learning that involves: determining a weight of a morpheme in a model that is either a linear model or a generalized linear model, in accordance with a feature determined based on a result of morphological analysis of learning data that is learning document data; and deleting, from input data of the model, the feature corresponding to the morpheme having the weight determined to be smaller than, or equal to, a given threshold value; obtaining document data including an electronic mail transmitted and received by a monitored person; determining the feature to be input to the learned model in accordance with the result of the morphological analysis of the obtained document data; inputting the determined feature to the learned model, in order to calculate a score indicating a degree of relevance between the document data and a given event; and performing display control based on the score of the document data.

### BRIEF DESCRIPTION OF THE DRAWINGS

FIG. 1 illustrates an exemplary configuration of an e-mail monitoring system including an information processing device;

FIG. 2 illustrates an exemplary configuration of the information processing device;

FIG. 3 illustrates an exemplary configuration of the information processing device (a score managing unit);

FIG. 4 illustrates another exemplary configuration of the information processing device (the score managing unit);

FIG. 5 is a flowchart showing processing of receiving an e-mail;

FIG. 6 is an exemplary screen for e-mail reception setting;

FIG. 7 is a flowchart showing processing of generating a learned model (a teacher model);

FIG. 8 is an exemplary screen for learned model generation setting;

FIG. 9 is a flowchart showing scoring processing, using the learned model;

FIG. 10 is an exemplary screen for scoring processing execution setting;

FIG. 11A is an exemplary screen for filtering setting;

FIG. 11B is an exemplary screen for the filtering setting;

FIG. 11C is an exemplary screen for the filtering setting;

FIG. 11D is an exemplary screen for the filtering setting;

FIG. 11E is an exemplary screen for the filtering setting;

FIG. 11F is an exemplary screen for the filtering setting;

FIG. 11G is an exemplary screen for the filtering setting;

FIG. 12A is an exemplary review screen for displaying a result of the scoring processing;

FIG. 12B is an exemplary review screen for displaying a result of the scoring processing;

FIG. 13 is a flowchart showing learning processing;

FIG. 14 is a graph showing processing of correcting a score to probability data;

FIG. 15A is a table showing metadata features;

FIG. 15B is a table showing processing of correcting metadata features in accordance with a first norm;

FIG. 15C is a table showing processing of correcting metadata features in accordance with a second norm;

FIG. 16A is a diagram of highlight processing in accordance with a score for each block;

FIG. 16B shows an example of information representing weights of the respective morphemes;

FIG. 17 is a graph showing a forecast line, a forecast curve, and a confidence interval; and

FIG. 18 is a diagram showing processing of obtaining a plurality of evaluation data items.

### DETAILED DESCRIPTION OF THE INVENTION

Described below will be an embodiment, with reference to the drawings. Throughout the drawings, identical reference signs are used to denote identical or substantially identical constituent features. Such constituent features will not be elaborated upon repeatedly. Note that this embodiment described below will not unduly limit the description recited in the claims. Furthermore, not all of the configurations described in this embodiment are necessarily essential constituent features of the present disclosure.

### 1. Example of System Configuration

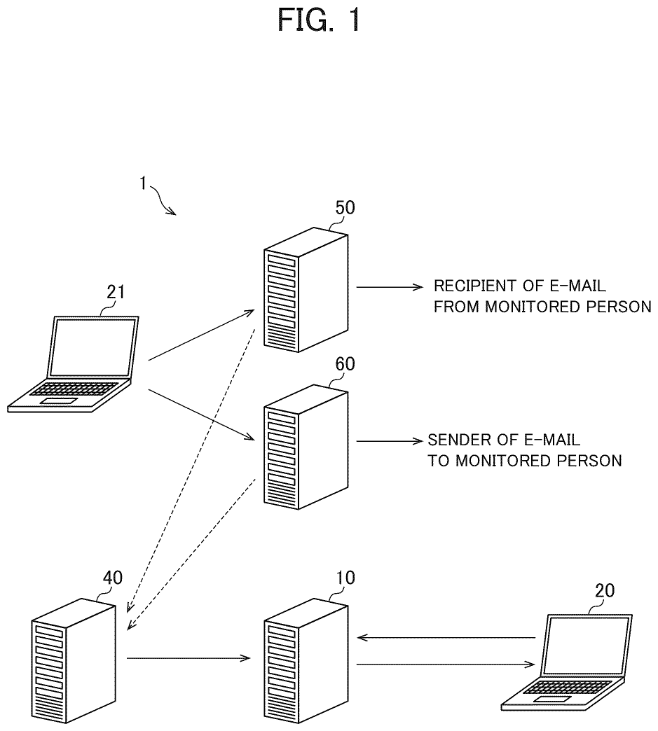

FIG. 1 is an exemplary configuration of an e-mail monitoring system 1 including an information processing device 10 according to this embodiment. The e-mail monitoring system 1 includes: an information processing device 10; a terminal device 20; a second terminal device 21; a monitoring e-mail server 40; a simple mail transfer protocol (SMTP) server 50; and a post office protocol (POP) server 60. Note that a configuration of the e-mail monitoring system 1 shall not be limited to the configuration illustrated in FIG. 1. The configuration can be subjected to various modifications, such as either omitting a portion of the configuration or adding another configuration.

The e-mail monitoring system 1 according to this embodiment is a system that monitors whether an electronic mail transmitted and received by a monitored person is relevant to a predetermined event. Hereinafter, in Specification, the electronic mail is also simply referred to as an e-mail. The event here includes various events such as formation of a cartel, information leakage, power harassment, and sexual harassment.

In FIG. 1, the terminal device 20 is a device used by a monitoring person who carries out monitoring. The second terminal device 21 is a device used by a monitored person who is a target of the monitoring. The terminal device 20 and the second terminal device 21 are, for example, personal computers (PCs). Note that each of the terminal device 20 and the second terminal device 21 may be such a device as a smartphone or a tablet terminal. Specific aspects of the terminal device 20 and the second terminal device 21 can be modified in various manners.

The SMTP server 50 is a server that transmits an e-mail according to a protocol referred to as SMTP or a protocol derived from SMTP. The POP server 60 is a server that receives an e-mail according to a protocol referred to as POP or a protocol derived from POP. Each of the SMTP server 50 and the POP server 60 may be either a server of, for example, an organization to which the monitored person belongs, or a server of a service provider (e.g., an internet service provider (ISP)) that provides an e-mail service. The monitored person transmits and receives e-mails from the second terminal device 21 through the SMTP server 50 and the POP server 60.

The monitoring e-mail server 40 periodically obtains e-mails transmitted and received by the monitored person. For example, the SMTP server 50 and the POP server 60 are set to perform a journal transfer function for periodically transferring e-mails to the monitoring e-mail server 40. Hence, the SMTP server 50 periodically transmits e-mails, transmitted by the monitored person, to the monitoring e-mail server 40. The POP server 60 periodically transmits e-mails, received by the monitored person, to the monitoring e-mail server 40. The monitoring e-mail server 40 accumulates the e-mails transferred from the SMTP server 50 and the POP server 60.

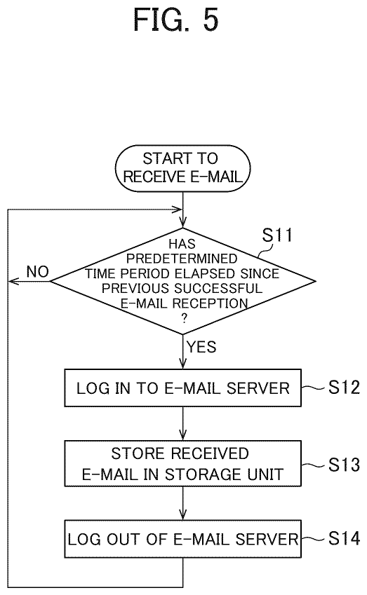

The information processing device 10 is a device to execute processing according to specific e-mail monitoring. The information processing device 10 may be provided in the form of, for example, a server system. Here, the server system may be a single server, or may include a plurality of servers. For example, the server system may include a database server and an application server. The database server stores various data items including a learned model to be described later. The application server executes processing to be described later with reference to, for example, FIGS. 5, 7, and 9. Note that, the plurality of servers here may be either physical servers or virtual servers. If the virtual servers are used, the virtual servers may be either provided to a single physical server or distributed among a plurality of physical servers. As can be seen, a specific configuration of the server system according to this embodiment can be modified in various manners. In other words, the information processing device 10 according to this embodiment may be provided in the form of either a single device, or a plurality of devices for distributed processing.

The information processing device 10 periodically receives e-mails to be monitored from the monitoring e-mail server 40. For example, the information processing device 10 may handle communications in accordance with the POP protocol or a derived protocol of the POP protocol to receive an e-mail from the monitoring e-mail server 40.

The information processing device 10 obtains a learned model (a teacher model) generated by machine learning, and executes processing (monitoring processing) of classifying the e-mails transmitted and received by the monitored person in accordance with the learned model. Specifically, the information processing device 10 performs processing of determining whether the e-mails transmitted and received by the monitored person are relevant to an event such as information leakage. Details of the processing will be described later.

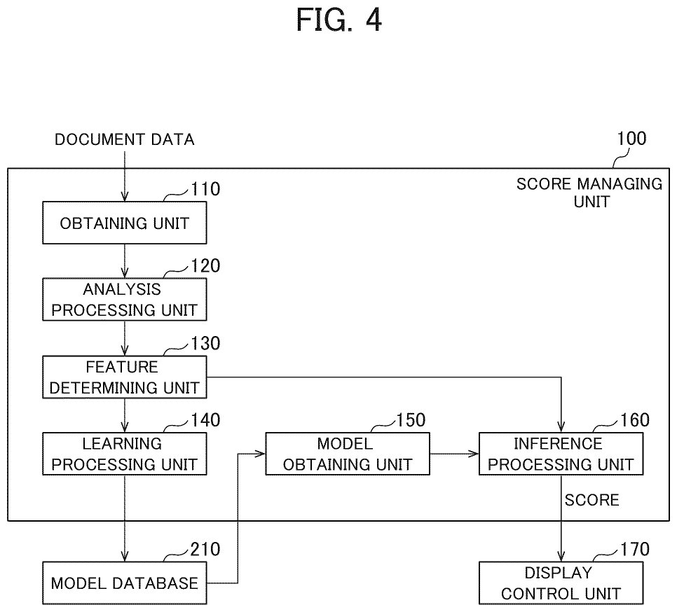

Here, the learned model may be generated by, for example, the information processing device 10. For example, as will be described later with reference to FIG. 4, the information processing device 10 includes a learning processing unit 140. The learning processing unit 140 performs machine learning to generate the learned model. Note that the technique of this embodiment shall not be limited to such a technique. The information processing device 10 may obtain a learned model generated by an external learning device.

The terminal device 20 is a device to be used by a monitoring person as described above. Here, the monitoring person may be either a person who belongs to the same organization as the monitored person does, or a person outside the organization. The terminal device 20 may run a web application using, for example, an Internet browser. For example, the information processing device 10 includes a web application server, and the browser of the terminal device 20 makes access to the web application server.

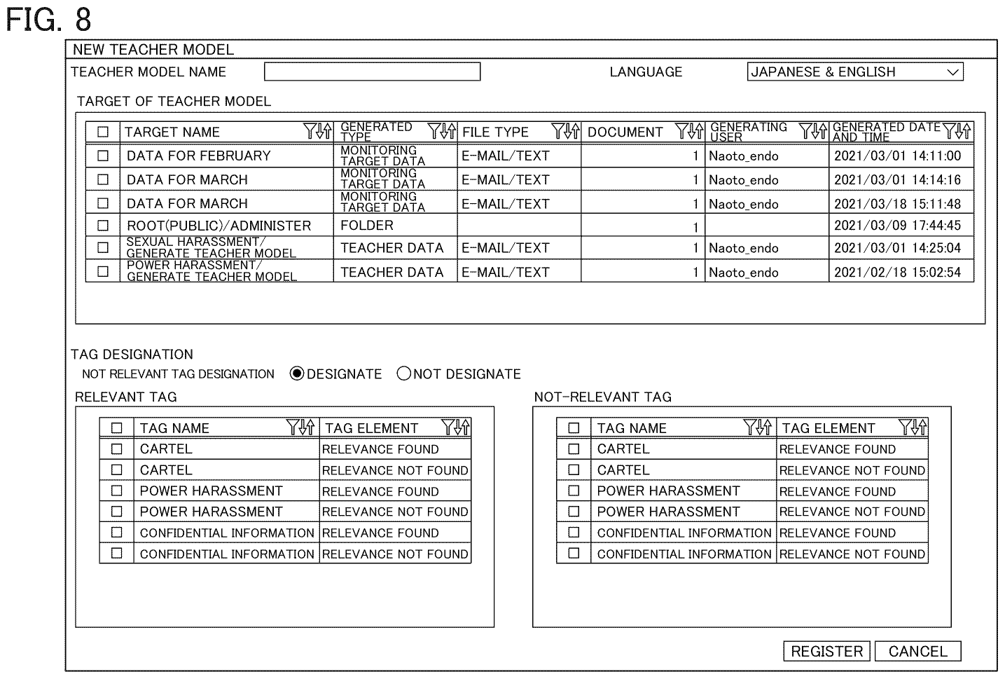

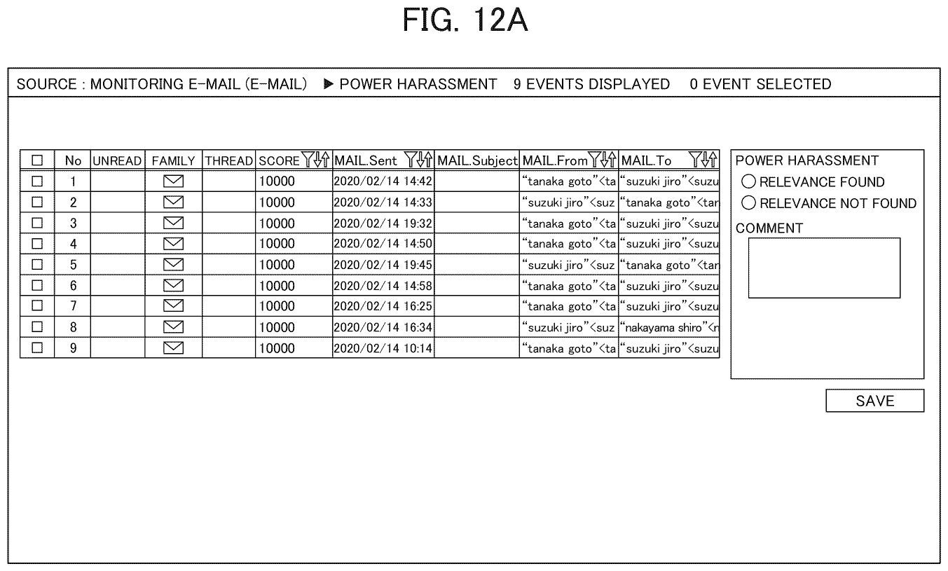

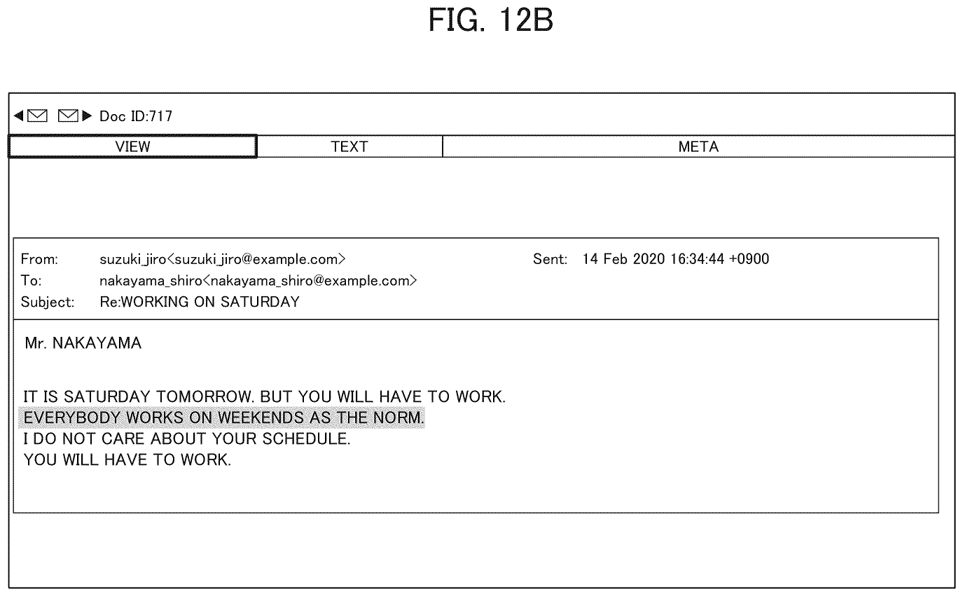

For example, the monitoring person uses an operation interface of the terminal device 20 to carry out operations such as selection of a learned model and a person to be monitored. Specific examples of a display screen to be used for the operations will be described later with reference to, for example, FIGS. 8, 10, and 11A to 11G. Results of the operations carried out by the monitoring person are transmitted to the information processing device 10 through a browser. The information processing device 10 identifies an e-mail to be monitored in accordance with an operation carried out by the monitoring person, and determines whether the e-mail is relevant to a given event, using a learned model. The monitoring person determines whether there is an e-mail actually relevant to a given event, in accordance with a result of the determination displayed on a screen of the browser. Examples of the display screen to be used for determination (a review) by the monitoring person will be described later with reference to FIGS. 12A and 12B.

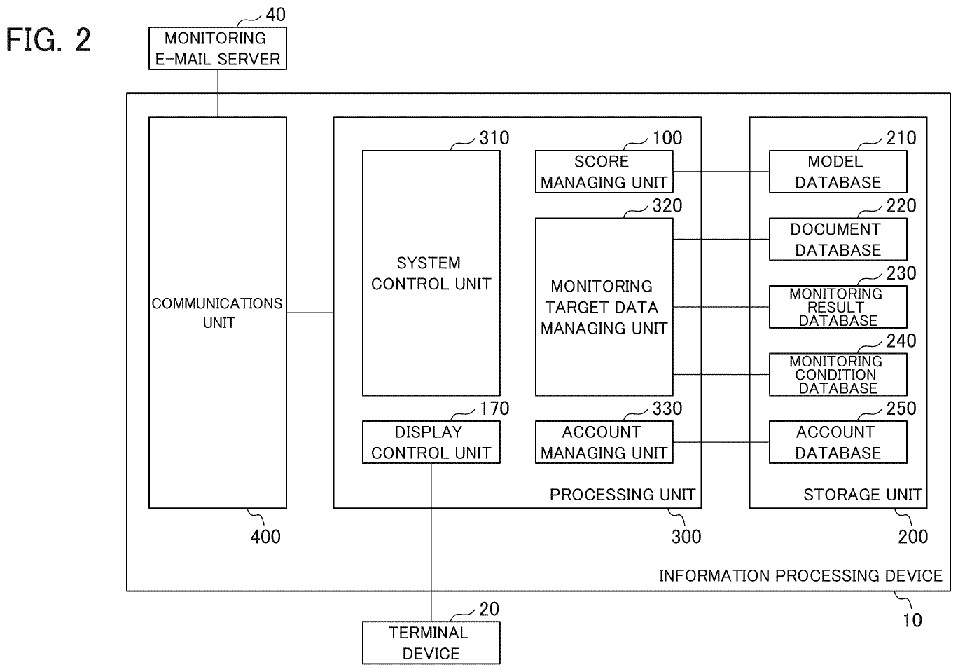

FIG. 2 is an exemplary configuration of the information processing device 10. As illustrated in FIG. 2, the information processing device 10 may include: a processing unit 300; a storage unit 200; and a communications unit 400. Note that a configuration of the information processing device 10 shall not be limited to the configuration illustrated in FIG. 2. The configuration can be subjected to various modifications, such as either adding a portion of the configuration, or adding another configuration.

The communications unit 400 includes a communications interface that handles communications with the monitoring e-mail server 40. Here, the communications interface may be either an interface that handles communications compliant with the IEEE802.11 standard, or an interface that handles communications compliant with another standard. The communications interface may include, for example, an antenna, a radio frequency (RF) circuit, and a baseband circuit. The communications unit 400 handles communications based on the POP protocol or a protocol derived from the POP protocol as described before, in order to receive an e-mail from the monitoring e-mail server 40.

The received e-mail is stored in a document database 220 of the storage unit 200. Note that a target to be monitored in this embodiment shall not be limited to e-mails. Alternatively, the target may include documents posted with a chat application and to a social networking service (SNS). Hence, hereinafter, the e-mails and the documents in the e-mails are referred to as document data. That is, the document database 220 illustrated in FIG. 2 may include e-mails and document data other than e-mails.

The processing unit 300 includes hardware below. The hardware can include at least one of a digital signal processing circuit or an analogue signal processing circuit. For example, the hardware can include one or a plurality of circuit devices mounted on a circuit board, and one or a plurality of circuit elements. The one or the plurality of circuit devices are, for example, integrated circuits (ICs) or field-programmable gate arrays (FPGAs). The one or plurality of circuit elements are, for example, resistors or capacitors.

Furthermore, the processing unit 300 may be provided in the form of a processor below. The information processing device 10 of this embodiment includes: a memory that stores information; and a processor that operates on the information stored in the memory. The information includes, for example, a program and various kinds of data. The program may include a program to cause the information processing device 10 to execute the processing described in this Specification. The processor includes hardware. The processor can include various kinds of processors such as, for example, a central processing unit (CPU), a graphics processing unit (GPU), and a digital signal processor (DSP). The memory may be: a semiconductor memory such as a static random access memory (SRAM), a dynamic random access memory (DRAM), or a flash memory; a resistor; a magnetic storage device such as a hard disk drive (HDD); or an optical storage device such as an optical disc drive. For example, the memory holds a computer-readable instruction. When the processor executes the instruction, a function of the processing unit 300 is carried out in the form of processing. Here, the instruction may be a set of instructions included in the program, or an instruction for instructing a hardware circuit of the processor to operate.

The processing unit 300 includes: a system control unit 310; a score managing unit 100; a monitoring target data managing unit 320; an account managing unit 330; and a display control unit 170. The system control unit 310 is connected to each of the units included in the processing unit 300, and controls the operation of each unit.

The score managing unit 100 performs processing on document data to be monitored, in accordance with a learned model, and outputs a score indicating a degree of relevance between the document data and a given event. For example, the score managing unit 100 reads: a learned model from a model database 210 of the storage unit 200; and document data to be monitored from the document database 220. Then, the score managing unit 100 calculates a score indicating a degree of relevance between the document data and a given event in accordance with the learned model and the document data.

The monitoring target data managing unit 320 stores, in a monitoring result database 230 of the storage unit 200, a result of processing performed by the score managing unit 100, in association with an ID assigned according to a monitoring condition and with original document data. The monitoring condition, which is a condition for monitoring the document data, is determined by a monitoring condition database 240 stored in the storage unit 200.

The account managing unit 330 performs, for example, management of: information on a login account of a monitoring person; and a monitored person whom the monitoring person can monitor. Login information and the information on the available monitored person are stored in an account database 250. The account managing unit 330 reads and updates the account database to execute management of accounts.

The display control unit 170 performs control to display a result of processing performed by the score managing unit 100. For example, the display control unit 170 causes a display unit of the terminal device 20 to display the result of the processing. Here, the display control may be processing of transmitting markup language for causing the display unit of the terminal device 20 to display a screen including the result of processing performed by the score managing unit 100. Note that the display control unit 170 may present the result of processing in a mode viewable for the user. A specific display control shall not be limited to the above control.

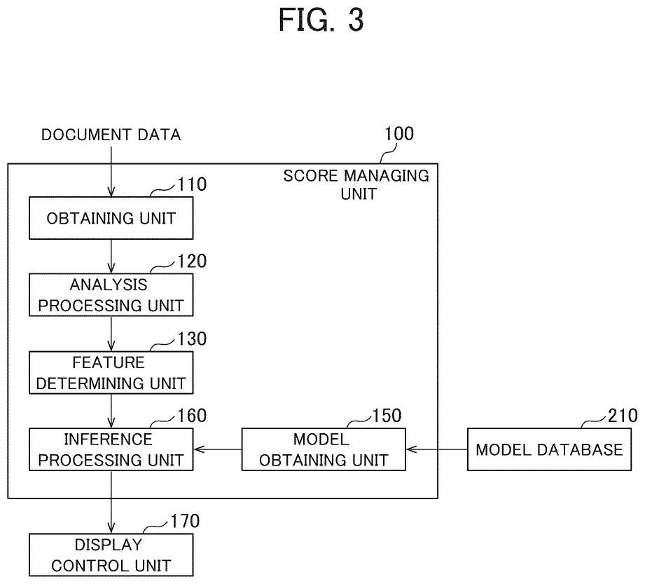

FIG. 3 is an exemplary configuration of the score managing unit 100. The score managing unit 100 includes: an obtaining unit 110; an analysis processing unit 120; a feature determining unit 130; a model obtaining unit 150; and an inference processing unit 160. Note that a configuration of the score managing unit 100 shall not be limited to the configuration illustrated in FIG. 3. The configuration can be subjected to various modifications, such as either adding a portion of the configuration, or adding another configuration.

The obtaining unit 110 obtains document data. For example, the obtaining unit 110 obtains, from the document database 220 stored in the storage unit 200, document data that meets a monitoring condition and serves as data to be monitored. The obtaining unit 110 may also obtain document data from the document database 220 through, for example, the monitoring target data managing unit 320.

The analysis processing unit 120 obtains document data from the obtaining unit 110, and performs morphological analysis of the obtained document data. The morphological analysis is a technique widely used in the field of natural language processing, and a detailed description of the analysis will not be elaborated upon here. The morphological analysis extracts, from one document data item, a plurality of morphemes included in the document data item.

The feature determining unit 130 determines a feature representing the document data item, in accordance with a result of the morphological analysis. Details of the feature will be described later.

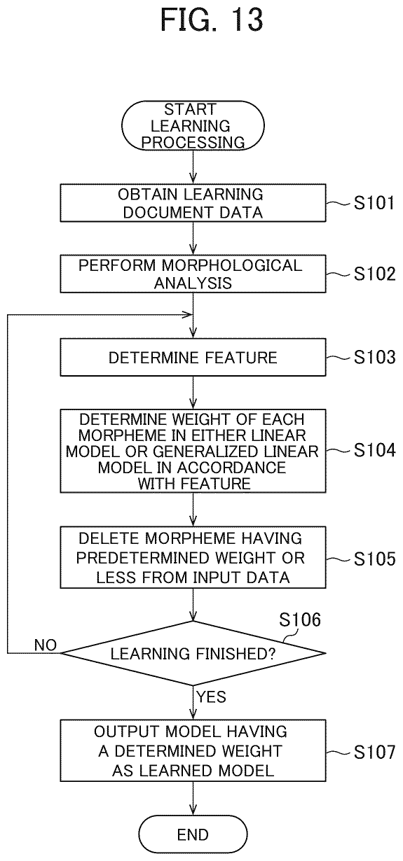

The model obtaining unit 150 obtains a learned model. Here, the learned model may be generated by machine learning. The machine learning may involve: determining a weight of a morpheme in a model that is either a linear model or a generalized linear model, in accordance with a feature determined based on the result of morphological analysis of learning data that is learning document data; and deleting, from input data of the model, the feature corresponding to the morpheme having the weight determined to be smaller than, or equal to, a given threshold value. Using the learned model, the morphemes can be automatically selected or rejected. This technique decreases the need for limiting the morphemes in the pre-processing, thereby making it possible to quickly execute the processing of monitoring e-mails with various morphemes set as targets. Details of the learned model in this embodiment will be described later with reference to FIGS. 13 to 18.

For example, the model obtaining unit 150 performs processing of reading out a desired learned model from the model database 210 of the storage unit 200. For example, the model database 210 may be a set of a plurality of learned models. For example, the model database 210 includes a plurality of learned models each directed to a different given event to be monitored. Specifically, the model database 210 may include: a learned model directed to cartel as a given event; and a learned model directed to information leakage as a given event. In such a case, the model obtaining unit 150 may perform processing of selecting a learned model that matches a monitoring condition.

The inference processing unit 160 performs inference processing (classification processing), using the learned model obtained by the model obtaining unit 150. Specifically, the inference processing unit 160 may input, to the learned model, a feature of a document data item to be subjected to the classification processing, in order to obtain a score of the document data item. As described above, the score represents a degree of relevance between the document data item and a given event.

The display control unit 170 causes the display unit of the terminal device 20 to display a screen including a result of the processing performed by the inference processing unit 160.

Furthermore, in addition to the inference processing performed using a learned model, the information processing device 10 may execute learning processing to generate the learned model. FIG. 4 illustrates another exemplary configuration of the score managing unit 100. The score managing unit 100 may include: the obtaining unit 110; the analysis processing unit 120; the feature determining unit 130; the model obtaining unit 150; and the inference processing unit 160, and additionally include the learning processing unit 140.

The obtaining unit 110 obtains learning document data. For example, the obtaining unit 110 may obtain learning data in which the document data is provided with a result of classification serving as answer data. Processing of providing the answer data (annotation) may be executed as, for example, feedback given when the user reviews a result of scoring using the learned model, as will be described later. The answer data may be data including a “tag name” indicating an event and a “tag element” indicating presence/absence of relevance, as will be specifically described later with reference to FIG. 8. Note that a device performing annotation and timing of executing annotation shall not be limited to the above examples. The device and the timing can be subjected to various modifications.

The analysis processing unit 120 obtains document data from the obtaining unit 110, and performs morphological analysis of the obtained document data. The feature determining unit 130 determines a feature representing the document data, in accordance with a result of the morphological analysis. The morphological analysis and the determination of the feature are the same as those carried out when the inference processing is performed.

The learning processing unit 140 performs machine learning to determine a weight of each of the plurality of morphemes in a model in accordance with the feature. The morphemes are obtained by the morphological analysis. The model in this embodiment is either a linear model or a generalized linear model. The linear model may be, for example, a model represented by an equation (1) below.

$$\begin{matrix}[ Math . 1 ] & \\ Document Score = f ( x ) = w 1 * x 1 + w 2 * x 2 + w 3 * x 3 + … + wn * xn & ( 1 )\end{matrix}$$

For example, the feature of a document data item in this embodiment may be a set of features of respective morphemes included in the plurality of morphemes. In the above equation (1), x1 to xn represent features corresponding to the respective morphemes, and w1 to wn represent weights of the respective morphemes. In the above equation (1), an objective variable of the model is a score of the document; that is, for example, a score indicating a degree to which, for example, a target document data item is relevant to a given event. Described below is an example in which a larger score indicates a higher degree of relevance between the document data item and the given event.

Furthermore, the generalized linear model is a model obtained when a linear model is generalized, and may be a model represented by, for example, an equation (2) below. Note that the generalized linear model shall not be limited to the model represented by the equation (2) below, and may be another model represented in accordance with a linear model f(x).

$$\begin{matrix}[ Math . 2 ] & \\ g ( x ) = \frac{1}{1 + f ( x )} & ( 2 )\end{matrix}$$

The technique of this embodiment uses either a linear model or a generalized linear model. Either model can reduce load on processing of learning, and over-training excessively adaptive to learning document data. Details of the processing on the learning processing unit 140 will be described later with reference to FIG. 13 and subsequent drawings.

The learning processing unit 140 outputs, as a learned model, either the linear model or the generalized linear model a weight of which is determined by the learning processing. For example, the learning processing unit 140 performs processing of adding the generated learned model to the model database 210 of the storage unit 200.

The model obtaining unit 150 obtains, from the model database 210, the learned model generated by the learning processing unit 140. The inference processing unit 160 monitors document data to be monitored, in accordance with the learned model obtained by the model obtaining unit 150.

Note that the obtaining unit 110, the analysis processing unit 120, and the feature determining unit 130 may perform both the learning processing and the inference processing. Specifically, the obtaining unit 110 obtains both the learning document data and the document data to be monitored. The analysis processing unit 120 performs morphological analysis on both the learning document data and the document data to be monitored. The feature determining unit 130 performs processing of obtaining both a feature of the learning document data and a feature of the document data to be monitored. As a result, the information processing device 10 (the score managing unit 100) can be simplified in configuration. Note that the learning processing and the inference processing may be performed by separate obtaining units, separate inference processing units, and separate feature determining units.

### 2. Details of Processing

Next, the processing of the information processing device 10 will be described with reference to an exemplary screen to be displayed on the display unit of the terminal device 20.

### 2.1 Receiving E-Mail

FIG. 5 is a flowchart showing processing of how the obtaining unit 110 obtains document data. Described below will be an example in which the document data is an e-mail. As described above, the document data may also include other data.

At Step S11, the information processing device 10 (the obtaining unit 110) determines whether a predetermined time period has elapsed since the previous successful e-mail reception. Here, the e-mail reception is, as described above, for example, processing of receiving an e-mail from the monitoring e-mail server 40, using the POP protocol or a protocol derived from the POP protocol. Here, a parameter such as the predetermined time period may be input on an e-mail setting screen used for setting of e-mail reception (hereinafter referred to as an e-mail setting).

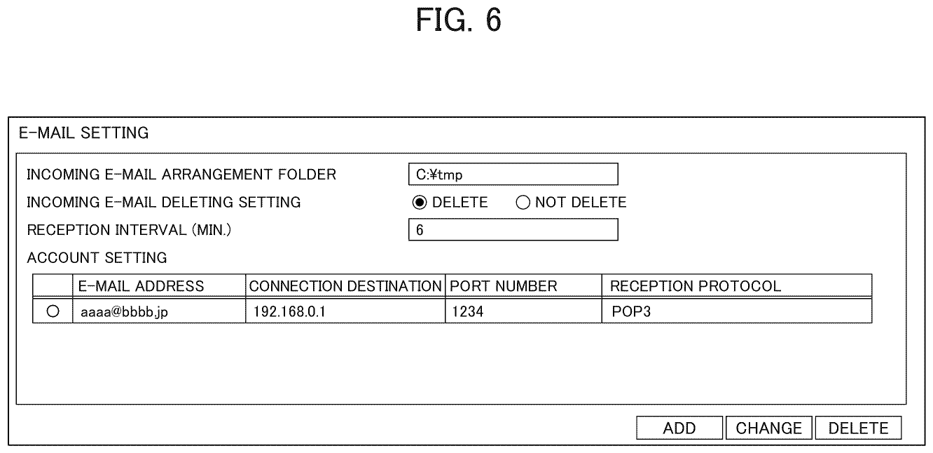

FIG. 6 is an example of the e-mail setting screen. The e-mail setting screen may be displayed on the display unit of the terminal device 20 used by the monitoring person. For example, the monitoring person accesses the application server of the information processing device 10, using the browser of the terminal device 20, in order to browse a screen for using the e-mail monitoring service. The monitoring person enters an account ID and a password on a home screen (not shown), and logs in to the e-mail monitoring service. The account ID is, for example, an e-mail address of the monitoring person. The e-mail setting screen illustrated in FIG. 6 may be displayed as one of user setting screens for changing the setting of the logged-in user after the login operation of the monitoring person. Note that, a system administrator who administers a plurality of monitoring people may carry out user setting for each of the monitoring people. In such a case, the screen in FIG. 6 may be displayed on the display unit of a terminal used by the system administrator.

As illustrated in FIG. 6, the e-mail setting screen may include items such as: incoming e-mail folder (incoming e-mail arrangement folder); incoming e-mail deleting setting; reception interval; and account setting.

The incoming e-mail folder is an item for setting which storage area (folder) of the storage unit 200 stores an e-mail received from the monitoring e-mail server 40. The incoming e-mail deleting setting is an item for determining whether to delete an e-mail, obtained by the obtaining unit 110, from the monitoring e-mail server 40. The reception interval is an item for determining the “predetermined time period” at Step S11.

The account setting is an item for selecting an account to be used for e-mail reception. For example, an e-mail address, a connection destination, a port number, and a reception protocol to be used for e-mail reception have already been set in advance as the account setting. The connection destination is information for identifying the monitoring e-mail server 40. For example, as illustrated in FIG. 6, an IP address is designated as the connection destination. Alternatively, other information such as a POP server name may be used as the connection destination. The port indicates a port number used for communications. The protocol indicates a protocol used for e-mail reception. FIG. 6 illustrates an example in which only one account is displayed for the account setting item. Alternatively, all the registered accounts may be displayed. In the account setting, for example, a radio button is displayed for selecting any one of the accounts.

In the example illustrated in FIG. 6, the user enters or selects an item value for each of the incoming e-mail folder, the incoming e-mail deleting setting, the reception interval, and the account setting. After that, the user selects and operates an add button so that e-mail setting information, which is a set of the item values, is stored in the storage unit 200. The e-mail setting information may be stored in, for example, either the monitoring condition database 240 or the account database 250.

Referring back to FIG. 5, the description will proceed. If the predetermined time period has not elapsed since the previous successful e-mail reception (Step S11: NO), the processing returns to Step S11 again, and continues. That is, the obtaining unit 110 pauses receiving e-mails until the predetermined time period elapses.

If the predetermined time period has elapsed after the previous successful e-mail reception (Step S11: YES), at Step S12, the obtaining unit 110 logs in to the monitoring e-mail server 40. Specifically, the obtaining unit 110 accesses the monitoring e-mail server 40; namely, the connection destination, in accordance with the e-mail setting information entered on the e-mail setting screen in FIG. 6, and receives an e-mail.

At Step S13, the obtaining unit 110 stores the obtained e-mail in the document database 220. The document database 220 may include a plurality of folders. The obtaining unit 110 stores the received e-mail in a folder included in the plurality of folders and designated with the e-mail setting information.

At Step S14, the obtaining unit 110 logs out of the monitoring e-mail server 40. The processing returns to Step S11. The obtaining unit 110 repeatedly executes the processing shown in FIG. 5 to perform processing of periodically receiving e-mails from the monitoring e-mail server 40 and adding the received e-mails to the document database 220.

### 2.2 Processing of Generating Learned Model

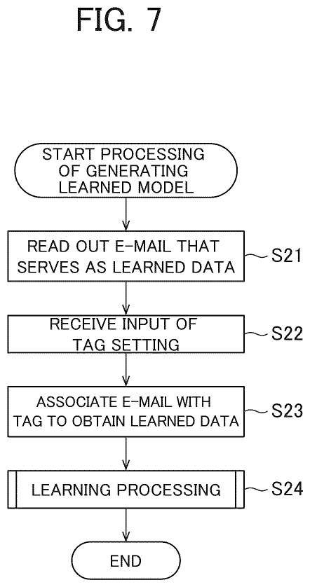

FIG. 7 is a flowchart showing that the learning processing unit 140, which is included in the information processing device 10, performs processing of generating a learned model and processing that accompanies the former processing. First, at Step S21, the processing unit 300 (e.g., the obtaining unit 110) reads out an e-mail that serves as learning data. For example, the processing unit 300 reads one or a plurality of e-mails from the document database 220. Here, the e-mails may be data with no answer data assigned thereto.

At Step S22, the processing unit 300 performs processing of accepting input setting of a tag. Here, the tag corresponds to the answer data. One tag may include: a “tag name” indicating a given event; and a “tag element” indicating presence/absence of relevance to the given event. For example, when the monitoring person would like to generate a learned model for monitoring cartel, the monitoring person selects a tag relevant to cartel; namely, (tag name, tag element)=(cartel, relevance found) or (cartel, relevance not found), and determines a tag to be assigned to the e-mail read out at Step S21.

Note that the tag setting by the user may be executed as feedback on the display of the monitoring result. For example, the inference processing unit 160 obtains a score of document data to be monitored, using an existing learned model, and determines that the document data is relevant to carter. In response to the determination, the monitoring person actually checks (reviews) the details of the document data on the screen to be described later with reference to, for example, FIGS. 12A and 12B. As a result of the review, the monitoring person may determine that the document data is relevant to cartel as presented by the inference processing unit 160. Whereas, the monitoring person may determine that the presentation of the inference processing unit 160 is incorrect and that the document data is not relevant to cartel.

The tag in this embodiment may indicate a result of determination made by the monitoring person. In the above example, if the monitoring person determines that the document data is relevant to cartel as presented by the inference processing unit 160, the monitoring person affirms (cartel, relevance found), and a relevant tag indicating (cartel, relevance found) is assigned. Whereas, if the monitoring person determines that the presentation of the inference processing unit 160 is incorrect, and that the document data is not relevant to cartel, the monitoring person denies (cartel, relevance found), and a not-relevant tag indicating (cartel, relevance not found) is assigned. Hence, the tag of this embodiment may have an attribute of relevant/not relevant in addition to the tag name and the tag element.

At Step S23, the processing unit 300 performs processing of associating the e-mail read out at Step S21 with the tag input as the answer data at Step S22. Hence, the answer data is assigned to the document data, thereby enabling supervised learning. Note that the processing at Step S23 is executed by, for example, the monitoring target data managing unit 320. Alternatively, the processing may be executed by, for example, the score managing unit 100.

At Step S24, the learning processing unit 140 performs machine learning, using the document data with the answer data assigned thereto. Details of the processing at Step S24 will be described later with reference to FIG. 13.

Note that the monitoring person who uses the terminal device 20 may perform setting for machine learning (hereinafter referred to as learning setting), using a learning setting screen. For example, the display control unit 170 causes the display unit of the terminal device 20 to display the learning setting screen.

FIG. 8 is an example of the learning setting screen. The learning setting screen may include items such as teacher model name, target of teacher model, and tag designation. The teacher model indicates a learned model. The teacher model name is an item for inputting a name of the learned model to be generated.

The target of teacher model indicates a set of document data items to be used for learning. The target includes items such as target name, generated type, file type, generating user, and generated date and time. The target name is a name indicating a target of interest. The generating user is information for identifying a user who generated the target of interest. The generated date and time is information for identifying the date and time when the target of interest was generated.

The generated type indicates a data type of the target, and may include, for example, monitoring target data, folder, and teacher data. The monitoring target data is data to be monitored. For example, the monitoring target data is data monitored during, for example, a specific period (February and March). The monitoring target data is a set of document data items. For example, if a tag is assigned to the monitoring target data through the feedback, the monitoring target data can be used for generating the learned model. Furthermore, the folder is a type indicating that an e-mail stored in a specific folder is a target. The teacher data is a set of document data items compiled with the intention of generating a specific learned model. The teacher data may be, for example, a set of document data items to which tags have already been assigned.

The file type indicates a type of the document data. The document data may be either an e-mail file (e.g., the file extension is msg) or a text file (e.g., the file extension is txt). Furthermore, the document data may include another type of data such as a document file (with an extension of docx).

The tag designation is an item for designating a tag to be used for machine learning. For example, when the monitoring person carries out monitoring for cartel, the monitoring person may select (tag name, tag element)=(cartel, relevance found) and (cartel, relevance not found) on the learning setting screen, and may exclude the other tags. Furthermore, when the monitoring person would like to monitor both cartel and power harassment together, the monitoring person may select, on the learning setting screen, (power harassment, relevance found) and (power harassment, relevance not found) in addition to the above two tags. That is, when the monitoring person appropriately determines whether to select or not to select a tag in the tag designation, a learned model can be generated for desired monitoring. Note that, as described above, the tags of this embodiment may indicate the feedback of the monitoring person on a result of the monitoring. Hence, the tags may include the relevant tag and the not-relevant tag, and whether to select or not to select may be determined for each of the relevant tag and the not-relevant tag.

### 2.3 Scoring Processing

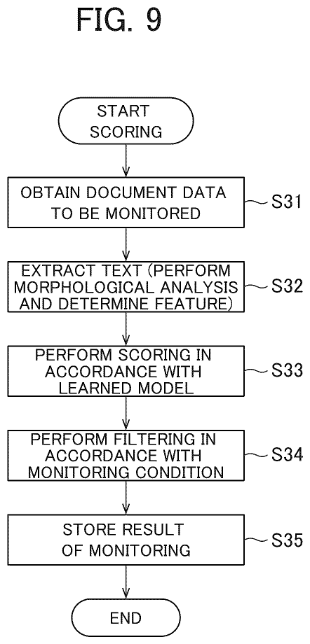

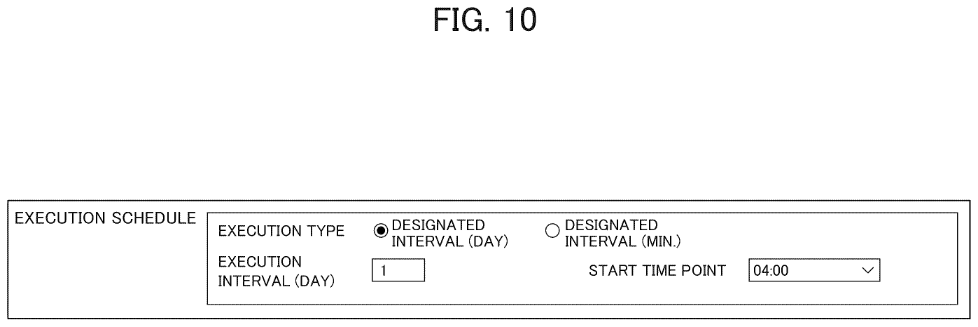

FIG. 9 is a flowchart showing scoring processing (inference processing and classification processing) performed by the score managing unit 100, using a learned model. FIG. 10 is an example of an execution setting screen for setting, for example, a time point of executing the scoring processing shown in FIG. 9. The execution setting screen is displayed on, for example, the display unit of the terminal device 20, and receives a selection operation carried out by the monitoring person.

As illustrated in FIG. 10, the execution setting screen includes items such as execution interval and start time point of the scoring processing. In the example of FIG. 10, the scoring managing unit 100 is set to start the scoring processing at 4:00 at one day intervals. Hence, the scoring processing starts at 4:00 AM every day. For example, when e-mails of company employees are monitored, a significantly large number of document data items are to be monitored. Hence, the scoring processing with a learned model would take several hours. In this regard, when the start time of the scoring processing is scheduled, the monitoring person can handle, for example, his or her operations more efficiently. Specifically, when the monitoring person starts his or her operations, the scoring managing unit 100 is set to have finished scoring of the e-mails of the previous day.

The score managing unit 100 starts the processing in FIG. 9 at a time point set on the execution setting screen. First, at Step S31, the obtaining unit 110 obtains, from the document database 220, a set of document data items to be monitored.

At Step S32, the analysis processing unit 120 performs morphological analysis of the document data to be monitored. The feature determining unit 130 determines a feature in accordance with a result of the morphological analysis.

At Step S33, the score managing unit 100 performs scoring based on a learned model. Specifically, the model obtaining unit 150 reads the learned model from the model database 210. The inference processing unit 160 inputs, to the learned model, a feature determined by the feature determining unit 130.

At Step S34, the inference processing unit 160 filters a result of monitoring in accordance with a monitoring condition. For example, the inference processing unit 160 reads a monitoring condition from the monitoring condition database 240, and executes filtering processing of extracting a portion of the result of monitoring in accordance with the monitoring condition. At Step S35, the inference processing unit 160 adds, in the form of the monitoring result, a result of the filtering processing to the monitoring result database 230 of the storage unit 200.

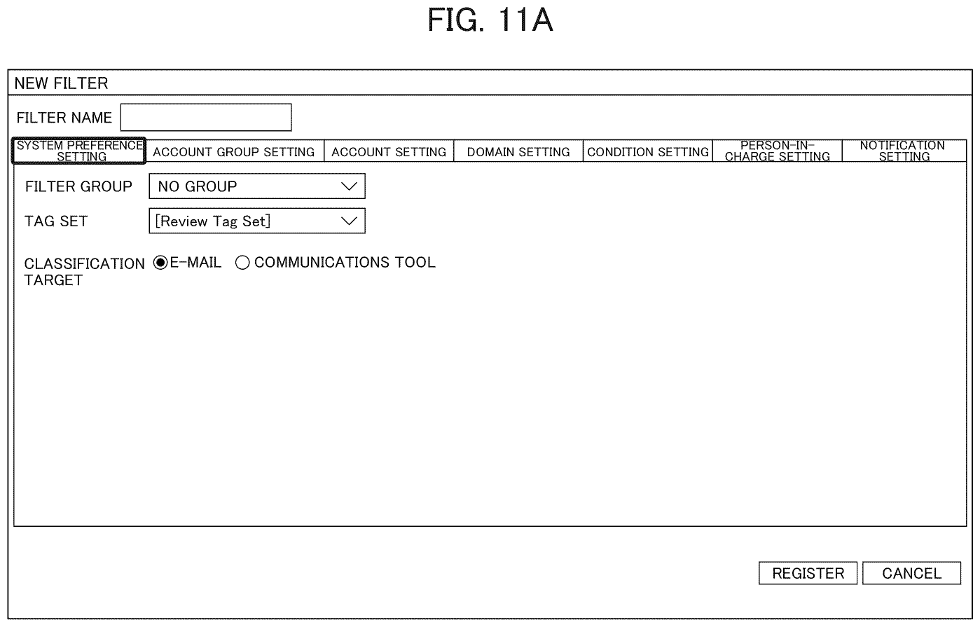

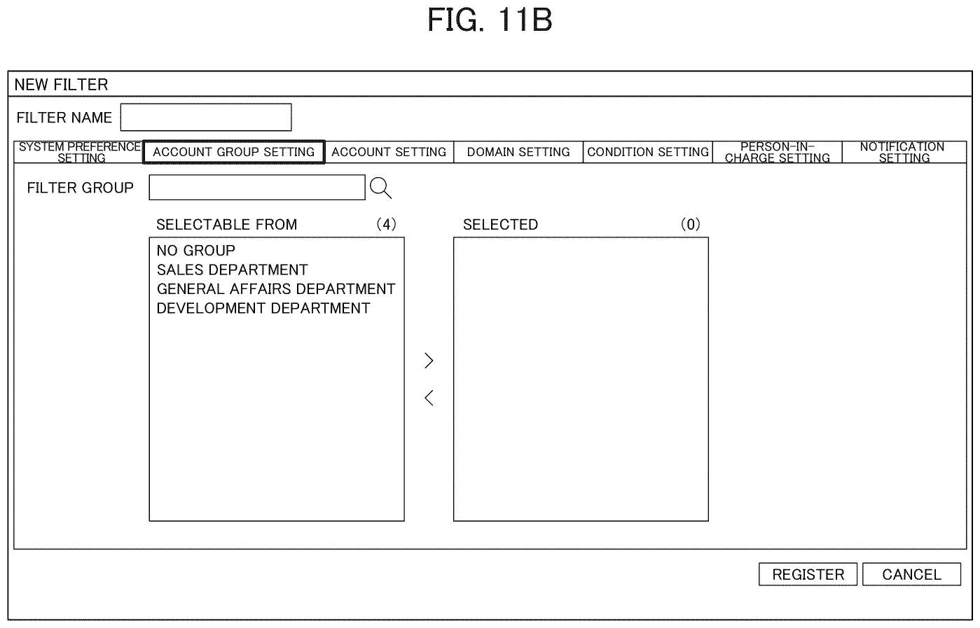

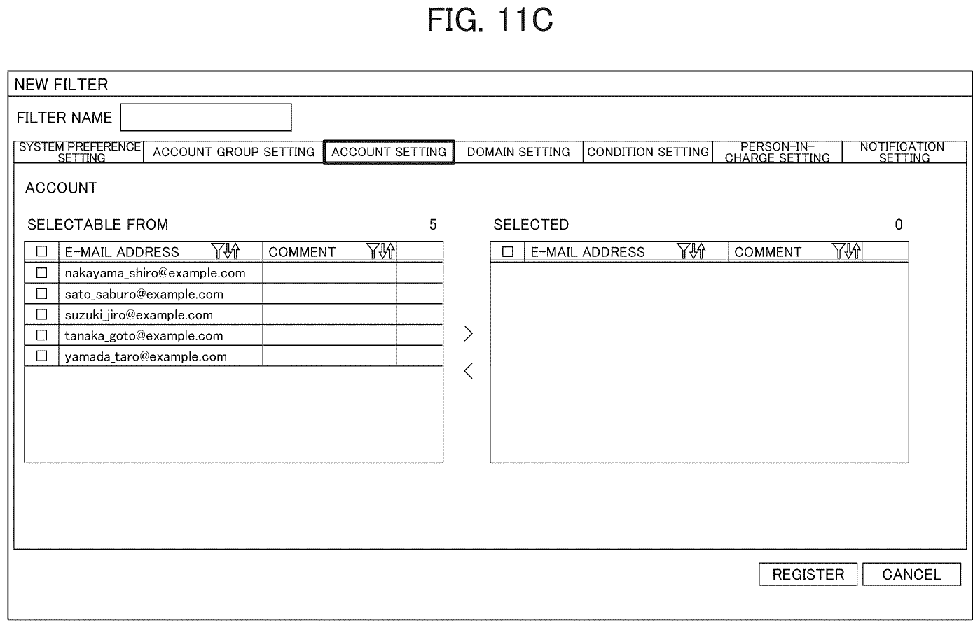

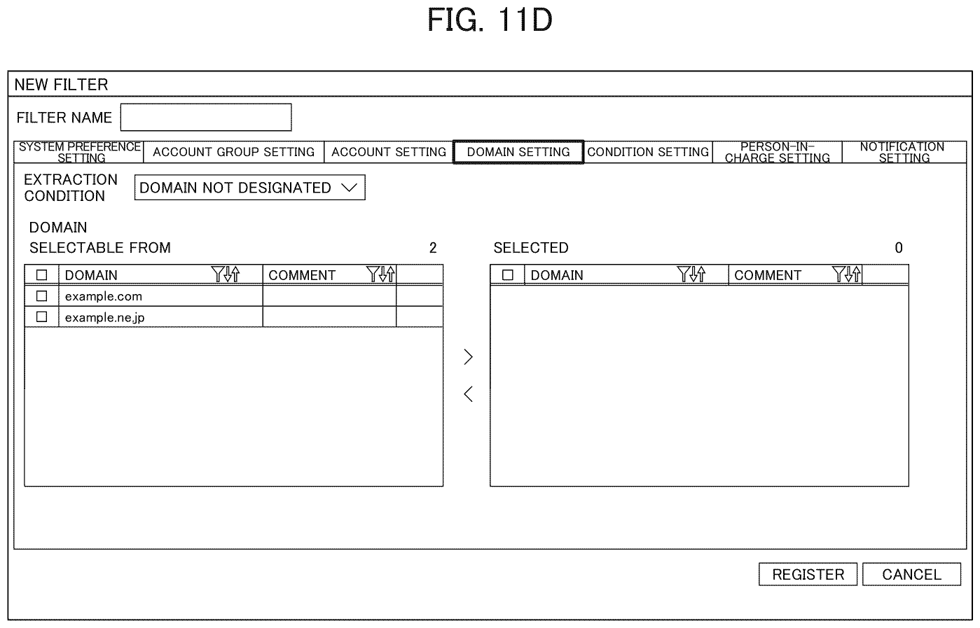

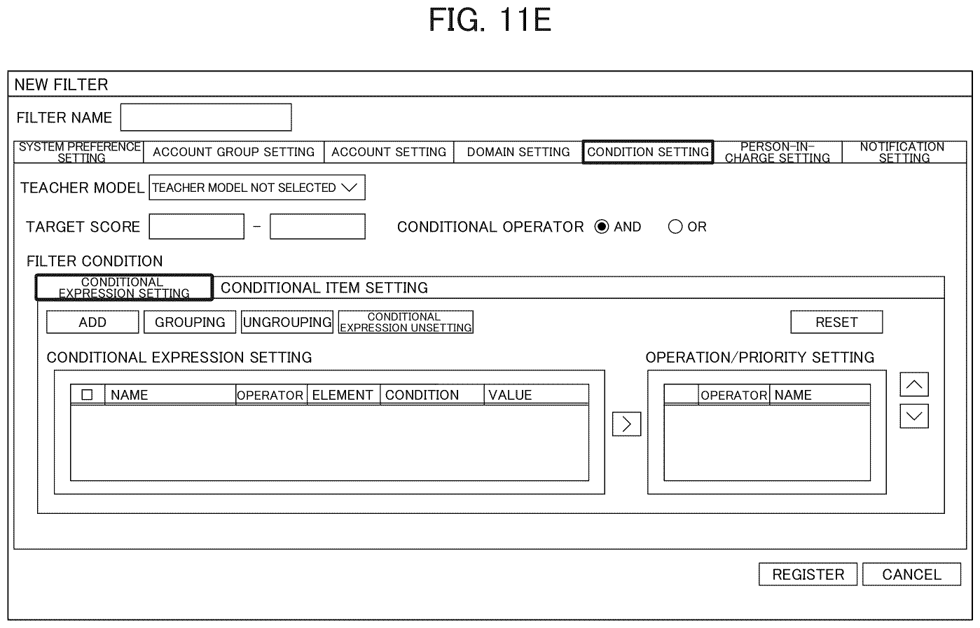

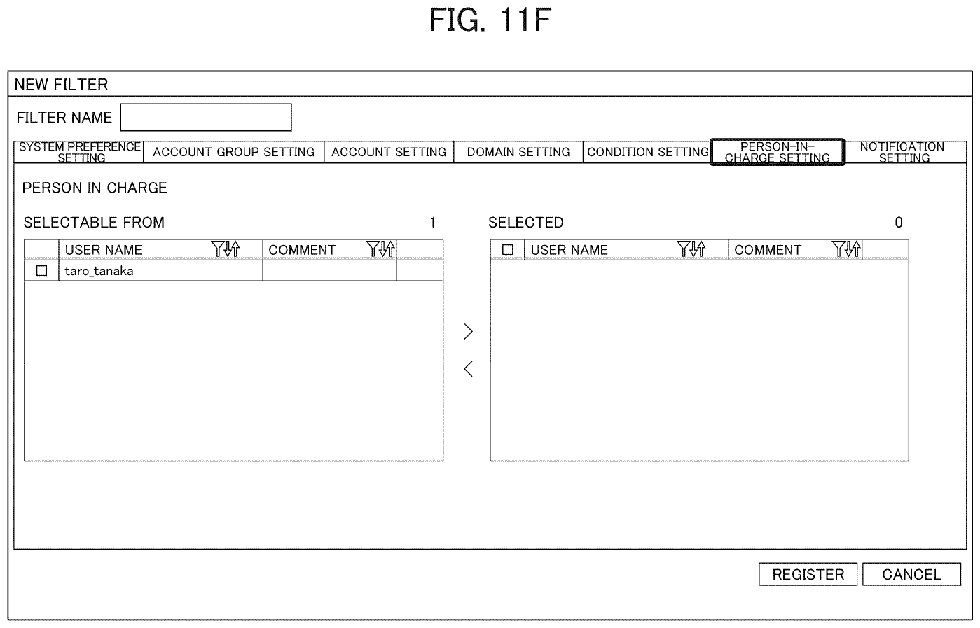

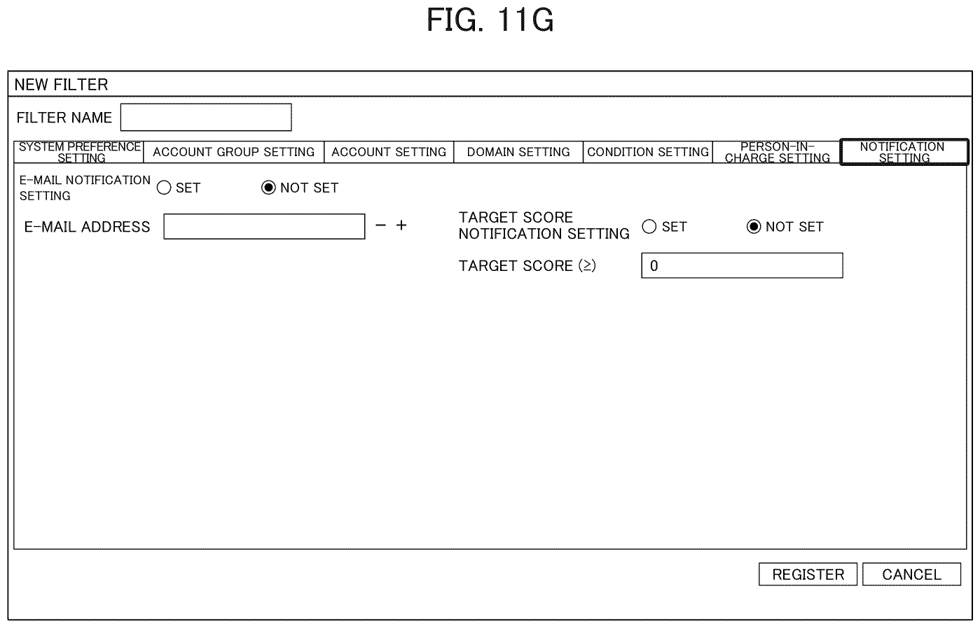

FIGS. 11A to 11G are examples of a monitoring setting screen for setting a monitoring condition. The monitoring setting screen is displayed on, for example, the display unit of the terminal device 20, and receives a selection operation carried out by the monitoring person. The monitoring person carries out monitoring setting before the processing in FIG. 9, using the monitoring setting screen. A result of the monitoring setting is stored in the monitoring condition database 240. The monitoring condition may be a condition for identifying a filter to narrow down document data items and people to be monitored. Hence, the monitoring setting screen illustrated in FIGS. 11A to 11G may also be referred to as a filter setting screen.

FIG. 11A is an example of a basic setting screen for setting a filter. On the basic setting screen, for example, a filter name (a monitoring condition name), a filter group, and a tag set can be set. The filter group is a function of grouping existing filters (monitoring conditions). For example, the function sets various groups for each event to be monitored or for each attribute of the monitored people, thereby facilitating management of the filters. The tag set is a set including, for example, one tag or a plurality of combined tags described with reference to FIG. 8. For example, a combination of tags is set in advance as a tag set. When the tag set is selected, the tags included in the tag set can be used as a condition of the filtering. Classification target is an item for filtering types of the document data. E-mail indicates e-mails, and communications tool indicates data of, for example, a chat tool or the SNS.

FIG. 11B is an example of a screen for setting a filter by account group. The account group is a set of a plurality of accounts. As illustrated in FIG. 11B, the account group may be a set of accounts for each of the departments of a company, such as a sales department, a general affairs department, and a development department. Note that the account group may be a set based on job title and job function, or a set based on age and sex. A specific account group can be modified in various manners. In the example of FIG. 11B, four existing account groups are displayed in the left pane, and an account group selected from the four existing account groups is added to the right pane. When any of account groups is selected, the only document data to be selected as a monitoring target is the one transmitted and received from the account that belongs to the account group.

FIG. 11C is an example of a screen for setting a filter for each account. Using this screen, the monitoring person can determine whether to monitor the document data for each individual account. In the example of FIG. 11C, five existing accounts are displayed in the left pane, and an account selected from the five existing accounts is added to the right pane. When any of the accounts is selected, the only document data to be selected as a monitoring target is the one transmitted and received from the account.

FIG. 11D is an example of a screen for setting a filter for each domain of an e-mail address. Using this screen, the monitoring person can determine whether to monitor the document data for each domain. In the example of FIG. 11D, two domains are displayed in the left pane, and a domain selected from the two domains is added to the right pane. When any of the domains is selected, the only document data to be selected as a monitoring target is the one transmitted and received from an e-mail address having the domain. Furthermore, as illustrated in FIG. 11D, the monitoring setting screen for domain may include a region for inputting whether to perform filtering by the domain (to designate the domain).

FIG. 11E is an example of a screen for setting a detailed monitoring condition. The screen illustrated in FIG. 11E displays a learned model to be extracted, and an item for setting either a lower limit value or an upper limit value of the score to be extracted, or both of the values. This screen makes it possible to extract only a scoring result obtained with a specific learned model, or to extract only a scoring result having a score in a specific range from among scoring results. Note that the monitoring conditions set in this embodiment may be stored in the form of conditional expressions. The monitoring person may use the screen illustrated in FIG. 11E to read and use an existing monitoring condition described in the form of a conditional expression, and to input setting of prioritizing a plurality of monitoring conditions and using the prioritized monitoring conditions in combination.

FIG. 11F is an example of a screen for setting a filter by a person in charge. Here, the person in charge may be a monitoring person. For example, if the learned model and the received e-mail are associated with the monitoring person, the score managing unit 100 may perform processing of extracting data associated with a specific monitoring person in accordance with the monitoring setting shown in FIG. 11F.

FIG. 11G is an example of a screen for setting a filter for notification setting. The screen illustrated in FIG. 11G may include items such as: ON/OFF of notification setting; setting of a destination e-mail address; and score threshold value as a notification condition. For example, the score managing unit 100 may extract document data having a score satisfying a condition of a score threshold value from a monitoring result. If the extracted document data exists, the score managing unit 100 may transmit information indicating the existence of the document data to the destination e-mail address. Here, the transmitted information may include: the number of extracted document data items and a summary (e.g., an e-mail title, a sender, and a recipient). Alternatively, the information transmitted to the destination e-mail address may be information indicating that a detailed review is necessary. Specific details of the document data may be displayed when the monitoring person accesses the information processing device 10, using the browser of the terminal device 20.

As can be seen, in this embodiment, various monitoring conditions are set, thereby making it possible to appropriately set a person and an event to be monitored, and to appropriately display information desired by the monitoring person.

### 2.4 Displaying Score

When the processing shown in FIG. 9 is performed, the monitoring result database 230 accumulates data indicating the monitoring results. For example, in receiving a request from the terminal device 20 for viewing a monitoring result, the display control unit 170 reads a monitoring result corresponding to the target monitoring person from the monitoring result database 230, and causes the display unit of the terminal device 20 to display the corresponding monitoring result. As described above, the monitoring results stored in the monitoring result database 230 may be results of filtering performed with a filter set on the screen in each of FIGS. 11A to 11G (Steps S34 and S35). The display control unit 170 may display information after the filtering.

FIGS. 12A and 12B illustrate exemplary review screens that present monitoring results to the monitoring person. For example, when the inference processing unit 160 obtains a plurality of inference target data items as the document data to be inferred, the inference processing unit 160 may calculate a score for each of the plurality of inference target data items. Then, the display control unit 170 performs control to display a list including only inference target data items having relatively high scores among the plurality of inference target data items. Here, the document data items having relatively high scores may include either a document data item having a score higher than, or equal to, a given threshold value, or a predetermined number of document data items in descending order of score among the document data items to be monitored.

Such a technique makes it possible to preferentially show the monitoring person a document data item having a high score; that is, a document data item estimated to be highly relevant to a given event. The monitoring person can preferentially review a document data item having a high score, thereby improving efficiency in review. As a result, the technique of this embodiment can reduce burden on the monitoring person.

Furthermore, the display control unit 170 may also perform control to display a list in which inference target data items included in the plurality of inference target data items and having relatively high scores are sorted in descending order of the scores. Such a technique displays, in descending order, document data items estimated to have high degrees of relevance to a given event, thereby making it possible to further improve efficiency when the monitoring person reviews the document data items.

FIG. 12A is an exemplary review screen for displaying a list of document data items having high scores. FIG. 12A shows an example in which the displayed list includes nine document data items. For each of the document data items, the list may include information on such items as: number; read/unread; family; thread; score; e-mail transmission time point; e-mail title; e-mail sender; and e-mail recipient.

The number is a number uniquely assigned to a document data item included in the list. The number may indicate a rank determined when the scores are sorted in descending order. The read/unread indicates whether a target e-mail is read or unread. When a plurality of e-mails are associated with one another to form a family (a group), the item family displays link information that links to information on a family to which the target e-mail belongs. The item thread displays information on a thread of the target e-mail. Here, the thread is a set of relevant e-mails grouped together in accordance with the history of, for example, reply to, and forwarding of, an e-mail.

The e-mail transmission time point indicates a time point when the target e-mail was transmitted. The e-mail title indicates a title attached to the target document data item. The e-mail sender indicates information for identifying the user name and the e-mail address of a user who sent the target e-mail. The e-mail recipient indicates information for identifying the user name and the e-mail address of a user who received the target e-mail. Although not shown in FIG. 12A, the list may include columns of Cc and Bcc. Cc denotes carbon copy and Bcc denotes blind carbon copy, indicating information for specifying user names and e-mail addresses of the users who share the target e-mail. Note that the information under Cc is information to be shared by all the e-mail recipients, and the information under Bcc is information not to be open to anybody but the e-mail sender.

The monitoring person who views the review screen of FIG. 12A refers to a score and other information displayed in association with the score, in order to select a document data item to be actually reviewed from the plurality of document data items included in the list.

FIG. 12B is an exemplary screen displayed when any one or more of the document data items are selected from the list. The exemplary screen is an example of a detail screen that displays the selected document data item in detail. When any one or more of the document data items are selected from the list, the display control unit 170 may perform control to display the details of the any one or more selected document data items in a window separate from a window displaying the list. For example, the screen illustrated in FIG. 12A and the screen illustrated in FIG. 12B are displayed in separate windows.

As illustrated in FIG. 12B, the detailed review displays specific description (text) of the target document data item. In this case, a portion of the text may be displayed in a different manner from the other portion of the text. FIG. 12B illustrates an example in which a color of the background in one row is changed. This processing is executed, for example, in accordance not with a score for each of the document data items, but with a score for each of the blocks generated when the document data item is divided into a plurality of blocks. Details of the processing performed for each block will be described later with reference to FIG. 16A.

As illustrated in FIG. 12B, the detail screen displays a lot of information. Hence, in order for the monitoring person to easily understand the description of the text, the detail screen is displayed desirably in a wide region to some degree. Whereas, the list illustrated in FIG. 12A could include many document data items. Hence, unless the screen of FIG. 12A is also displayed in a wide region to some degree, the monitoring person would have a difficulty in understanding the outline of document data that might be relevant to a given event. In this regard, the windows of the screens shown in FIGS. 12A and 12B are separated from each other. Such a technique allows the information to be displayed in an easily viewable manner, thereby reducing burden on the monitoring person.

Furthermore, when the user selects another document data item on the screen of FIG. 12A while the detail screen of FIG. 12B is open, the display control unit 170 may perform processing of updating the detail screen without opening a new window. For example, considered is an example in which an e-mail No. 2 is selected from the list of FIG. 12A while an e-mail No. 1 is displayed on the detail screen of FIG. 12B. In this case, the display control unit 170 performs control to change the e-mails to be displayed on the detail screen from No. 1 to No. 2. Such a technique reduces the problem of simultaneously opening the window of displaying the detail screen for No. 1 and the window of displaying the detail screen for No. 2, thereby facilitating the operation of the monitoring person. Note that if the monitoring person gives an explicit instruction to open multiple windows, the multiple windows may be opened simultaneously to display the detail screens.

Furthermore, as illustrated in FIG. 12A, the review screen may be provided with an item for inputting feedback of the monitoring person. The example of FIG. 12A shows that the given event is power harassment. In the example, a radio button is displayed for selectively inputting either relevance found or relevance not found. The monitoring person selects one or a plurality of document data items with the check boxes on the list, and clicks the save button while either relevance found or relevance not found is selected. For example, the monitoring person views detailed information in FIG. 12B to determine the relevance between the document data items and the event, and carry out an input operation in FIG. 12A in accordance with a result of the determination. Such a technique associates a tag with the target document data item. Note that, as illustrated in FIG. 12A, the monitoring person may enter a comment when giving feedback.

### 3. Score Managing Unit

Described next will be details of the score managing unit 100.

### 3.1 Flow of Learning Processing

FIG. 13 is a flowchart showing a processing flow according to this embodiment; that is, a flowchart showing learning processing for machine learning in accordance with, in particular, learning document data. This processing corresponds to, for example, Step S24 of FIG. 7. However, the processing shown in FIG. 13 may be executed with timing different from that of assigning a tag such as Steps S21 to S23.

First, at Step S101, the obtaining unit 110 obtains learning document data. For example, the obtaining unit 110 may obtain document data associated with a tag representing feedback of the monitoring person and serving as answer data.

At Step S102, the analysis processing unit 120 performs morphological analysis processing on learning document data. Here, a morpheme represents the smallest unit that makes sense language-wise in a sentence. The morphological analysis includes processing to break down the document data into a plurality of morphemes. The analysis processing unit 120 obtains, as a result of the morphological analysis, a set of morphemes included in the document data. Note that the analysis processing unit 120 may determine, for example, parts of speech of the morphemes, and the determination result may be included in the results of the morphological analysis. The morphological analysis is a technique widely used in the field of natural language processing, and a detailed description of the analysis will not be elaborated upon here.

At Step S103, the feature determining unit 130 determines a feature corresponding to the document data. For example, in accordance with an occurrence state of a given morpheme in the target document data, the feature determining unit 130 may perform processing of determining a value corresponding to the given morpheme. Then, the feature determining unit 130 may use a tensor (in a narrow sense, a vector) as a feature representing the target document data. In the tensor, values obtained for the respective morphemes are arranged.

For example, the feature determining unit 130 may use, as a value corresponding to a given morpheme, binary data indicating whether the morpheme is included in the document data. The binary data may be data representing: a first value (e.g., 1) when the morpheme is included in the document data; and a second value (e.g., 0) when the morpheme is not included in the document data. For example, if the target document data includes three morphemes of “Impossible is nothing”, the feature of the document data is a vector indicating that values of elements corresponding to “Impossible”, “is”, and “nothing” are 1, and values of the other elements are 0.

Alternatively, the feature determining unit 130 may use, as a value corresponding to a given morpheme, a value based on term frequency (tf) representing occurrence frequency of the morpheme. Furthermore, the feature determining unit 130 may use, as a value corresponding to a given morpheme, a value determined in accordance with tf and inverse document frequency (idf).

At Step S104, the learning processing unit 140 performs learning processing using a feature as input data of a model. Specifically, x1 to xn in the equations (1) and (2) correspond to the features (the elements of the vectors) determined at Step S103, and a score of the document data corresponds to the answer data. The learning processing unit 140 performs processing to determine the most probable weights w1 to wn, in accordance with a set of (scores x1, x2 . . . xn) obtained from many learning document data items. Various known linear optimization techniques, including the steepest descent, the Newton's method, and the primal-dual interior-point method, are employed for processing of determining a weight for the linear model. These techniques are widely applicable to this embodiment.

At Step 105, the learning processing unit 140 executes processing of excluding, from subsequent learning processing, a morpheme included in a plurality of morphemes and having a corresponding weight value smaller than, or equal to, a predetermined threshold value. For example, the learning processing unit 140 performs processing of deleting, from input data of the model, the feature corresponding to the morpheme having a value of the weight determined to be smaller than, or equal to, a given threshold value. More specifically, if the weight wi (i is an integer of 1 or more and n or less) corresponding to a given morpheme is determined to be smaller than, or equal to, a predetermined threshold, the learning processing unit 140 may delete a term corresponding to wi×xi from the model represented by the above equations (1) and (2). As a result, the i-th morpheme corresponding to xi is excluded from the targets of the learning process.

The technique of this embodiment allows the learning processing unit 140 to automatically determine whether a given morpheme is used for processing. Hence, for example, in performing the learning processing first at Step 104, the technique can reduce necessity for performing processing of reducing load, such as partially filtering a morpheme in advance. In a narrow sense, the learning processing unit 140 may use all the morphemes, extracted from the learning document data, for the learning processing. Alternatively, the learning processing unit 140 may use features, corresponding to all the morphemes assumed in a target natural language, for the learning processing.

As can be seen, the technique of this embodiment eliminates the need for previously excluding some of the morphemes, thereby successfully reducing load accompanied by pre-processing of the learning processing. For example, when a morpheme is erroneously detected because of an error in morphological analysis, a conventional technique performs processing of excluding an inappropriate morpheme. In contrast, this embodiment can automatically exclude such an inappropriate morpheme. This is because the influence of the inappropriate morpheme is little on the degree of relevance between the document data and a given event. Thus, in the processing at Step S104, a small weight deemed to be spontaneously set. For example, as to languages such as Chinese, Japanese, and Korean languages, one morpheme could have a very low character count. Hence, it is more difficult to execute morphological analysis on those languages than on other languages (e.g., English language). The technique of this embodiment has an advantage in that, even if such languages as Chinese, Korean, and Japanese languages are the target languages, errors in morphological analysis can be automatically excluded in the learning process.

Furthermore, the document data according to this embodiment may be voice data, and the voice data may be obtained by voice recognition processing. In this case, the audio recognition processing might make an error, and an inappropriate morpheme might be obtained. However, this embodiment automatically removes such an inappropriate morpheme. This is because even if the cause of the error is the audio recognition processing, it is also deemed that the influence of the inappropriate morpheme is little on the degree of relevance between the document data and a given event. That is, the technique of this embodiment can automatically remove, using a model of the learning processing, an error that might occur in processing in a previous stage of the learning processing such as voice recognition processing and morphological analysis.

Note that, as to the technique of this embodiment, it is also important that the model is either a linear model or a generalized linear model. It is because, as described above with reference to FIG. 13, this embodiment first executes processing of determining weights first for many (in a narrow sense, all) morphemes (Step S104), and then, using a result of the processing, automatically excludes some of the morphemes (Step S105). Hence, processing for many morphemes is required at least once. When a model to be used has a relatively large processing load (e.g., a neural network having multiple intermediate layers), the morphemes in large numbers, that is, input data items in large numbers, inevitably increase load on processing for determining the weights at first. Such a problem could impair the advantageous effect of reducing the load by automatically excluding some of the morphemes. In this regard, as described above, using either a linear model or a generalized linear model that is mathematically easy to analyze, the technique of this embodiment can efficiently determine the weights even if many morphemes are processed, thereby successfully and appropriately reducing the load on the learning processing.

After deleting morphemes having a predetermined weight or less, at Step 106, the learning processing unit 140 determines whether to finish the learning processing. For example, the learning processing unit 140 may perform cross validation to obtain an index value representing accuracy of the learning, and determine whether to finish the learning in accordance with the index value. The cross validation is a technique of dividing a plurality of learning data items into N units (N is an integer of 2 or more), updating the weights using N−1 units among the N units as training data, and obtaining the index value using the remaining 1 unit as test data (validation data). The cross validation is a known technique, and a detailed description of the technique will not be elaborated upon here. Furthermore, the index value here can include various index values such as a recall, an accuracy rate, a precision, and an area under the curve (AUC).

If the learning processing unit 140 determines not to finish the learning (Step $106: NO), the learning processing unit 140 returns to, for example, Step S103, and performs processing. In this case, the features corresponding to the morphemes are recalculated, and, in accordance with the recalculated features, the weights of the morphemes are determined. Here, a morpheme deleted at Step 105 may be excluded from the morphemes subjected to feature calculation. Furthermore, at Step 104, a control parameter to be used for the learning may be partially changed.

Alternatively, if the learning processing unit 140 determines not to finish the learning (Step S106: NO), the learning processing unit 140 may return to, for example, Step S104, and perform processing. In this case, the learning processing unit 140 uses a determined value for the feature, partially changes the control parameter different from the feature, and then again executes the processing of determining the weight.

If the learning processing unit 140 determines to finish the learning (Step $106: NO), the learning processing unit 140 outputs, as a learned model, either the linear model or the generalized linear model a weight of which is determined at that time. Then, the learning processing unit 140 finishes the learning processing.

### 3.2 Probability Data Output

As described above, the score in this embodiment may be a value determined in accordance with an output value of a model. Here, the score is, for example, information indicating a degree of relevance between document data and a given event, as described above. The score may also be numerical data indicating likelihood that the document data item and the given event are relevant to each other. For example, the score is information indicating that the greater the value of the score is, the higher the degree of relevance is between the document data and the given event.

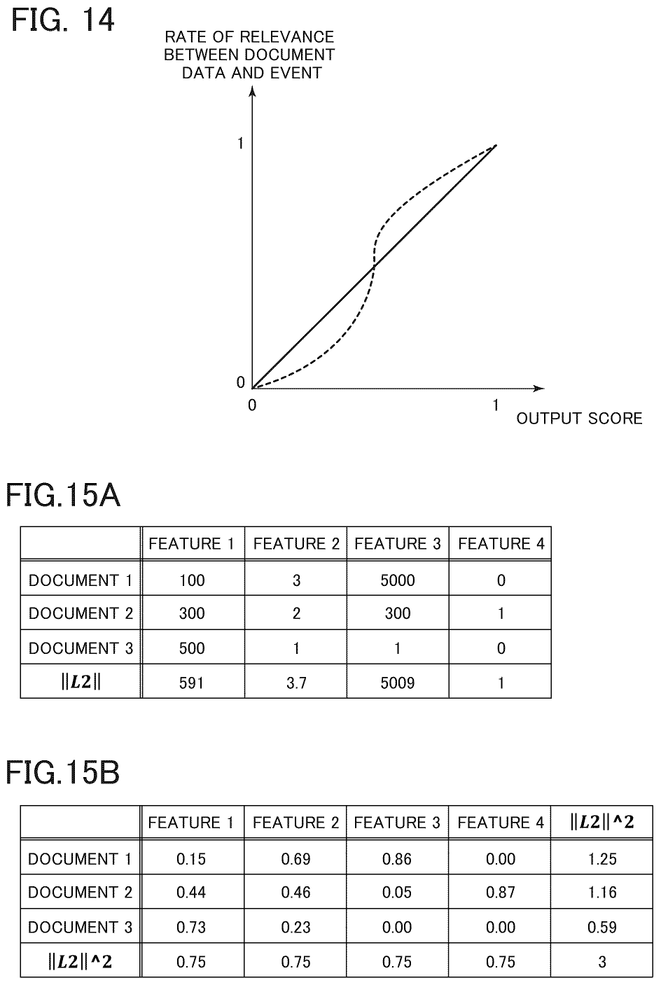

FIG. 14 shows information indicating an output value of a model and a rate of relevance between document data items and a given event. The horizontal axis of FIG. 14 indicates an output value of the model. The vertical axis of FIG. 14 indicates a ratio of the number of document data items actually relevant to a given event to the total number of document data items for which, for example, an output value of the model is a given value. The value of the vertical axis of FIG. 14 may be determined in accordance with, for example, test data for the cross validation. For example, a plurality of document data items included in the test data are input into a learned model, and, as a result, Ns document data items each having a score S are to be obtained. With reference to the answer data of the Ns document data items, x document data items out of the Ns document data items are found to be relevant to a given event, and the rest of the document data items (i.e., (Ns−x) document data items) are found not to be relevant to the given event. In this case, the value Ps of the vertical axis when the value of the horizontal axis is S is expressed as Ps=(x/Ns). Hereinafter, the value of the vertical axis is referred to as a “rate of document data items relevant to a given event”, and is also simply referred to as a “rate”.

In this case, the score and the rate might not be in a linear relationship. For example, as shown by the broken line of FIG. 14, the rate might be a non-linear function in relation to the score. Note that, in FIG. 14, the score is normalized to a value of 0 or more and 1 or less; however, the score may be represented in any given manner.

For example, if the score is 20% of a maximum value (e.g., 0.2), the user viewing the score might determine that the document data item is relevant to the given event with a probability of 20%. However, when the score is 0.2 in the example of FIG. 14, the value of the rate of the vertical axis is smaller than 0.2. That is, the probability is lower than 20% as to the relevance of the document data item having a score of 0.2 to the given event. Likewise, when the score is 0.8 in the example of FIG. 14, the value of the rate of the vertical axis is larger than 0.8. That is, the probability is higher than 80% as to the relevance of the document data item having a score of 0.8 to the given event. Hence, when the score and the rate are in a non-linear relationship, deviation is observed between the impression that the user feels from the value of the score and the actual rate.

Furthermore, the relationship between the score and the rate might vary depending on learning document data. For example, different learning document data is used when the information processing device 10 of this embodiment is used either for the discovery support system or for the e-mail monitoring system. This means that the relationship between the scores and the rates varies between the two systems, and the meaning of the scores is different for each system. Furthermore, even in the e-mail monitoring system, the relationship between the scores and the rates could be different in a case where the given event is directed to either power harassment or sexual harassment.

Hence, this embodiment may perform processing of correcting a score to reduce deviation between the score and the rate. Specifically, the information processing device 10 performs correction processing so that the rate approximates to a liner function of the score. Here, the correction processing may be, for example, correction processing of approximating a value of the score to a value of the actual rate. For example, if S is a value of a pre-corrected score, which is an output of a model, and Ps is a value of a rate corresponding to the pre-corrected score, the value of the pre-corrected score is corrected to approximate from S to Ps. This correction can match the value of the corrected score with the value of the rate corresponding to the corrected score. In the example of FIG. 14, the relationship between the score and the rate is corrected so that the broken line is transformed into the solid line.

For example, the information processing device 10 obtains relationship data indicating a correspondence relationship between a score and a rate, using the test data for the cross validation as described above. Here, the relationship data may be a function F in which a relationship of a rate=F (score) holds, or may be data in the form of a table in which a value of a score and a value of a rate are associated with each other. If the relationship data is known, the value Ps of a rate can be determined when the value of the pre-corrected score is S. Hence, the correction described above can be appropriately executed.

As a result of the correction processing, for example, if the corrected score is 20% of the maximum value, it is expected that the target document data is relevant to the given event with a probability of approximately 20%. That is, the inference processing unit 160 may output, as a score (the corrected score described above), probability data indicating probability that inference target data is related to the given event. Such a score can associate the impression, which the user has when he or she views the score, with the rate. Furthermore, the technique of this embodiment can use the corrected score as probability data, regardless of a kind of the given event. That is, the meaning of the score is constant regardless of a system to which the information processing device 10 is applied or of a difference between events to be handled in the system. As a result, the user can easily make a decision. Furthermore, when filtering is performed with a score in display control of the display control unit 170, the user can uniform criterion for the decision making in the filtering, regardless of a system or a given event.

Note that, exemplified above is a case where an output of the model is obtained as the pre-corrected score, and, after that, the correction processing is performed on the pre-corrected score in accordance with the relationship data. The correction processing is carried out when, for example, the learning processing unit 140 obtains the relationship data between the pre-corrected score and the rate at the learning stage, and the inference processing unit 160 executes the correction processing at the inference stage in accordance with the relationship data. Note that, the correction processing of this embodiment shall not be limited to such an example. For example, the information processing device 10 may perform processing of correcting the weights w1 to wn so that the output of the model is the corrected score. That is, the learning processing on the learning processing unit 140 may involve executing the correction processing.

### 3.3 Automatic Parameter Setting

As described above with reference to FIG. 13, the learning processing unit 140 determines whether to finish the learning processing in accordance with an index value (Step S106). If the learning processing unit 140 determines not to finish the learning processing, the learning processing unit 140 continues the learning processing. When continuing the learning process, the learning processing unit 140 may make any given setting change related to the learning processing, and again perform processing of determining a weight of a morpheme.

The learning processing unit 140 may be capable of performing ensemble learning of obtaining, as the model, a plurality of models to be used in combination in the inference processing. Specifically, the learning processing unit 140 may be switchable between whether or not to execute the ensemble learning (switchable between ON and OFF of the ensemble learning). For example, as to the ensemble learning, a technique referred to as bagging is known. The bagging is to obtain a plurality of training data items with diversity, using bootstrapping, to obtain a plurality of models from the plurality of training data items, and to perform estimation using the plurality of models. Other than the bagging, the ensemble learning includes various known techniques such as boosting, stacking, and neural networking. These techniques are widely applicable to this embodiment.

For example, the learning processing unit 140 may perform processing of evaluating the model obtained in the learning processing (Step S106). If performance of the model is determined to be lower than, or equal to, a predetermined level (Step S106: NO), the learning processing unit 140 may cancel ensemble in the ensemble learning (turn OFF the ensemble learning), and continue the machine learning. In other words, the learning processing unit 140 of this embodiment may automatically change a control parameter for determining ON and OFF of the ensemble learning.

The ensemble learning is deemed higher in accuracy than learning processing using a single model. However, if a sufficient amount of learning data is unavailable, the ensemble learning could even decrease estimation accuracy. For example, as to the systems assumed to be used in this embodiment, such as the discovery support system and the e-mail monitoring system, a rate of document data items relevant to a given event is assumed significantly low among collected document data items. Hence, even if a large number of document data items are collected in total, an amount of data classified into one category (the number of document data items relevant to a given event) might be insufficient. In this case, too, the ensemble learning could decrease accuracy. In this regard, this embodiment can automatically switch ON and OFF of the ensemble learning, while evaluating a created model. As a result, this embodiment allows execution of appropriate learning processing in accordance with a collection state of the learning document data items.

Alternatively, the learning processing unit 140 performs processing of evaluating a model. If performance of the model is determined to be lower than, or equal to, a predetermined level in the processing of evaluating, the learning processing unit 140 may continue the machine learning while the feature determining unit 130 changes a feature model to be used for determining the feature. Here, the feature model is a model for determining a value corresponding to each of the morphemes in the document data, in accordance with an occurrence state of each morpheme. As described above, the feature model may be a model that assigns binary data to each morpheme, a model that assigns a value corresponding to tf to each morpheme, or a model that assigns a value corresponding to tf-idf to each morpheme. Alternatively, the feature model may be a model other than these models.

For example, if target document data is a long sentence having a predetermined word count or more, or is expressed in a literary language even if the target document data is a short sentence, the accuracy is likely to be higher when tf is used than when binary data is used. Whereas, as to document data expressed in a short sentence and a literary language, it has been found out that the accuracy is likely to be higher when a simple feature model with binary data is used than when tf is used. The technique of this embodiment automatically changes the feature model, thereby successfully executing appropriate learning processing in accordance with, for example, a length of document data and an expression used in the document data.

Alternatively, the learning processing unit 140 performs processing of evaluating the model. If performance of the model is determined to be lower than, or equal to, a predetermined level in the processing of evaluating, the learning processing unit 140 may change the model (a function model) used for the machine learning, and continue the machine learning. For example, if performance of a learned model, obtained using the linear model represented by the above equation (1), is determined to be lower than, or equal to, a predetermined level, the learning processing unit 140 may change the learned model to the generalized linear model represented by the equation (2), and perform the machine learning. Furthermore, the learning processing unit 140 may change the generalized linear model to the linear model. Moreover, as described above, an aspect of the generalized linear model shall not be limited to the above equation (2). For example, the storage unit 200 may store a plurality of different generalized linear models. If performance of the model is determined to be lower than, or equal to, a predetermined level in the processing of evaluating, the learning processing unit 140 may perform processing of changing the function model on any one of unselected models among the linear model and the plurality of generalized linear models. In addition, various modifications can be made to the technique of changing the model (the function model).

### 3.4 Metadata

Furthermore, in this embodiment, metadata may be assigned to document data. Here, the metadata includes, for example, a character count and a line count in the document data, and the distribution and statistic of these counts (e.g., an average value, a center value, standard deviation). Moreover, the document data of this embodiment may be data including a transcript of a conversation among a plurality of people. For example, the obtaining unit 110 may obtain voice data that is a recorded conversation, and perform voice recognition processing on the voice data, in order to obtain the document data. In this case, the metadata of the document data includes, for example, a character count in a speech, a line count in the speech, and a time period of the speech, for each person. For example, if the document data is for a conversation between a customer and an employee, the metadata includes, for example, a character count in the customer's speech, a character count in the employee's speech, and time distribution. Furthermore, the metadata may include, for example, a rate of a character count in the customer's speech, and a rate a character count in the employee's speech, with respect to a character count in the whole conversation. For example, the metadata may include the name of a file path where the document data is stored, and the time and date when an e-mail is exchanged.

The metadata may be used for learning processing. For example, the feature determining unit 130 may determine a metadata feature in accordance with metadata assigned to document data. The metadata feature is a feature corresponding to the metadata. The learning processing unit 140 performs machine learning in accordance with a feature corresponding to a morpheme and the metadata feature. Hence, the metadata different from the morpheme can be included in the feature, thereby successfully improving learning accuracy.

Note that, in the learning process, the learning processing unit 140 may obtain a weight corresponding to metadata, and delete, from input data of a model, metadata whose weight has a value equal to, or smaller than, a predetermined threshold value. In this way, not only morphemes but also metadata can be automatically selected using a model, thereby eliminating the need of a person previously selecting the morphemes and the metadata in accordance with, for example, experience of the person.

Note that, a value of the metadata could vary widely for each data item. For example, a character count in a speech is likely to be great compared with a line count in a speech. Furthermore, a time period of a speech could vary depending on whether the time period is counted by either seconds or minutes. Hence, if a value of the metadata is used as it is as a feature, a feature having a large value greatly affects the learning model, and the whole feature could not be learned thoroughly. Moreover, if a decision tree or a random forest is used, the learning can be conducted regardless of the difference in units or scales. However, these techniques exhibit strong nonlinearity, and are not used in this embodiment as described above.

For example, considered is a case where first to P-th pre-corrected features are obtained as pre-corrected features corresponding to metadata, and where first to Q-th documents are obtained as document data. P represents the number of kinds of the features corresponding to the metadata, and Q represents the number of document data items. Here, each of P and Q is an integer of 1 or more. Note that, in reality, it is assumed that there are multiple kinds of metadata and multiple document data items. Hence, each of P and Q may be an integer of 2 or more.

The feature determining unit 130 may correct the first to the P-th pre-corrected features in accordance with the P of the pre-corrected features, the Q of the document data items, a first norm obtained with an i-th pre-corrected feature (i is an integer of 1 or more and P or less) that appears in the first to the Q-th documents, and a second norm obtained with the first to P-th pre-corrected features that appear in a j-th (j is an integer of 1 or more and Q or less) document, in order to determine the metadata feature. In this way, the metadata feature can be appropriately normalized. Specifically, the correction based on the first norm can reduce a difference in value between metadata items, thereby successfully conducting appropriate learning even in a case where either a linear model or a generalized linear model is used. Furthermore, the correction based on the second norm is also performed, thereby successfully unifying information (e.g., sum of squares) corresponding to the sum of the features for each of the documents. As a result, a format of the feature to be obtained is the same as a format of the feature directed only to language information (morphemes). Hence, also in the case where the metadata is used, the learning can be conducted by the same processing as the processing for the language information.

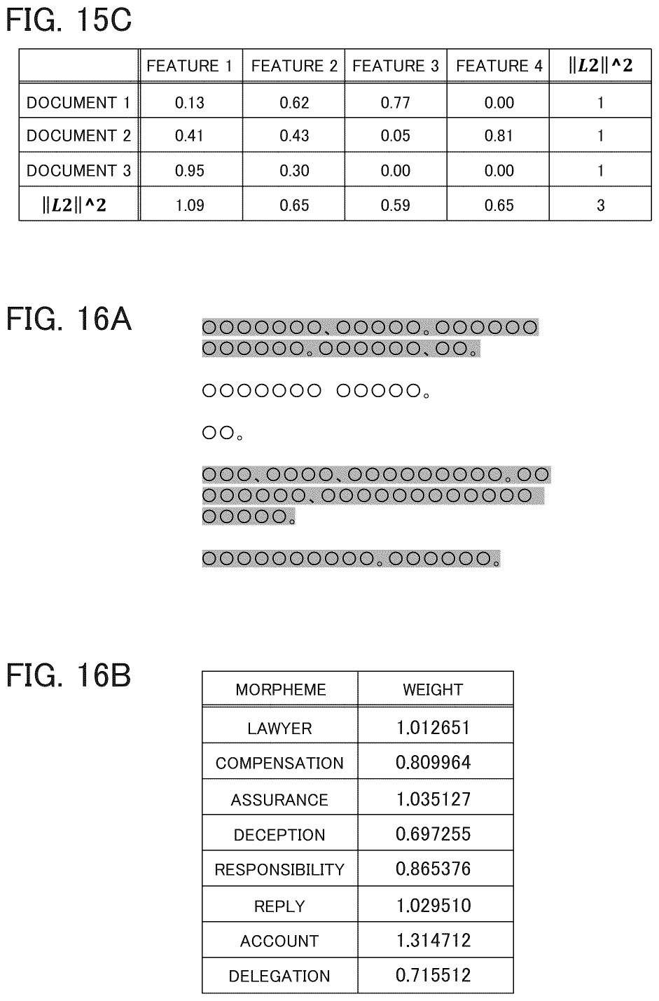

FIGS. 15A to 15C are tables specifically showing processing of correcting (normalizing) metadata features. FIG. 15A is a table showing pre-corrected metadata features. Here, exemplified is a case of documents 1 to 3 with four metadata features and three document data items. That is, exemplified is a case where P is 4 and Q is 3.

As shown in FIG. 15A, the values of the metadata feature 1 are 100, 300, and 500 for the respective documents 1, 2, and 3. The values of the metadata feature 2 are 3, 2, and 1 for the respective documents 1, 2, and 3. The values of the metadata feature 3 are 5000, 300, and 1 for the respective documents 1, 2, and 3. The values of the metadata feature 4 are 0, 1, and 0 for the respective documents 1, 2, and 3. In this example, the influence of the metadata features 1 and 3 are relatively strong. In FIG. 15A, |L2| represents an L2 norm; that is, a square root of the sum of squares. An L2 norm in the vertical direction is a norm obtained with the i-th pre-corrected feature (i is an integer of 1 or more and P or less) that appear in the first to the Q-th documents. Hence the L2 norm corresponds to the first norm.

FIG. 15B is a table showing correction processing using P, Q, and the first norm. FIG. 15B is a table showing a result of the correction processing represented by an equation (3) below for each of the elements in FIG. 15A. For example, the result of the correction processing performed on the metadata feature 1 is obtained by multiplication of (1/591)×√(3/4). The correction processing shown in FIG. 15B uniforms the values with the square of L2 norms in the vertical direction to read 0.75 for all the metadata features. This correction processing can reduce the influence of the scale for each metadata feature.

$$\begin{matrix}[ Math . 3 ] & \\ Feature Corrected with First Norm = Pre - Corrected Feature \times \frac{1}{First Norm} \times \frac{\sqrt{Number of Documents}}{Number of Features} & ( 3 )\end{matrix}$$

Furthermore, an L2 norm in the horizontal direction in FIG. 15B is a norm obtained with the first to the P-th pre-corrected features that appear in the j-th (j is an integer of 1 or more and Q or less) document. Hence, the L2 norm corresponds to the second norm. FIG. 15B clearly shows variation in metadata features; that is, the document 1 has large values of the metadata features as a whole, while the document 3 has small values of the metadata features as a whole. In this embodiment, the variation may be reduced by the correction processing using the second norm.

FIG. 15C is a table showing correction processing using the second norm. FIG. 15C is a table showing a result of the correction processing of multiplying each of the elements in FIG. 15B by 1/(the second norm). For example, the result of the correction processing performed on the document 1 is obtained when each of the elements is multiplied by (1/√1.25). The correction processing shown in FIG. 15C uniforms the values with the square of L2 norms in the horizontal direction to read 1 for all the metadata documents. This correction processing can make the format of the feature the same as a format of the feature directed only to language information. Note that the correction processing performed on the metadata features is represented as an equation (4) below.

$$\begin{matrix}[ Math . 4 ] & \\ Corrected Feature = Pre - Corrected Feature \times \frac{1}{First Norm} \times \frac{\sqrt{Number of Documents}}{\sqrt{Number of Features}} \times \frac{1}{Second Norm} & ( 4 )\end{matrix}$$

### 3.5 Highlighting by the Block

The inference processing unit 160 of this embodiment may perform processing of: dividing inference target data into a plurality of blocks in any given length; and outputting probability data for each of the plurality of blocks. The probability data is provided as a score, and indicates a probability relevant to a given event. Note that the probability data here is obtained by the technique described above with reference to FIG. 14. Furthermore, the score may be the probability data itself of 0 to 1 inclusive (from 0% to 100% inclusive), or may be a value obtained by multiplication of the probability data by a given constant. For example, the score may be numerical data of 0 to 10000 inclusive.

The technique of this embodiment can calculate not only probability data of document data as a whole but also probability data of a block representing a portion of the document data. Hence, the technique can appropriately identify a portion deemed to be particularly important in the document data. Note that the block may be, but shall not be limited to, a paragraph, for example. Alternatively, the block may be set to include a plurality of paragraphs. Furthermore, one paragraph may be separated into a plurality of blocks. Moreover, the blocks may overlap with one another. In other words, the document data may have a given portion included in a first block and in a second block different from the first block. Furthermore, the blocks may be set either automatically or manually by user input.

For example, the feature determining unit 130 may obtain for each of the blocks a feature representing the block, and the inference processing unit 160 may input the feature into a learned model to obtain the probability data. Alternatively, the inference processing unit 160 may identify a morpheme included in a target block, and obtain a score of the block using a weight (any one of w1 to wn) corresponding to the morpheme.

The techniques using a decision tree and a random forest involve assessment using a feature, when determining a branch destination of each binary tree. Hence, when input document data is short and the number of the kinds of morphemes included in the document data is fewer than, or equal to, a predetermined number, a feature serving as a criteria of the assessment cannot be obtained. As a result, many binary trees cannot properly make determination to branch off. Consequently, in the techniques using, for example, a decision tree, processing accuracy could be significantly low when a short block is processed. In this regard, the technique of this embodiment uses either a linear model or a generalized linear model. Hence, a weight of each of the morphemes is calculated in the learning processing. Hence, even if the document data to be classified is short, the processing for obtaining a score using the weight can be appropriately executed, so that the estimation can be made with high accuracy even by the block.

For example, the inference processing unit 160 may compare, for each of the plurality of blocks, a score and a threshold value independent of a genre of the inference target data, and determine a display mode of each block in accordance with a result of the comparison. As described above, the score is corrected in a form of probability data, so that a difference between genres (specifically, kinds of given events whose degrees of relevance are to be determined) can be absorbed, and the meanings of the scores can be uniformed. Hence, the criteria assessment can be uniformed regardless of what the given event is. For example, if a range of the score is set from 0 to 10000 inclusive, the inference processing unit 160 may determine that the scores 1000 to 2499 inclusive are displayed in a first color, the scores 2500 to 3999 inclusive are displayed in a second color, and the scores 4000 to 10000 inclusive are displayed in a third color. The display control unit 170 executes control for displaying each block, using a display mode determined on the inference processing unit 160. For example, the display control unit 170 may perform display control to color a character or a background of each of the blocks in either basic colors (a black character and a white background) or any one of the first to the third colors, depending on the score. Note that the first to third colors may be any specific colors as long as the colors can be distinguished from each other.

FIG. 16A is a diagram illustrating an example of a result of display control performed by the display control unit 170. In the example in FIG. 16A, the document data is divided into five blocks, and a first, a fourth, and a fifth blocks among the five blocks mark high scores. Hence, the display control unit 170 executes display control of changing a color of the backgrounds. Note that an example of the display control shall not be limited to this example. The example can be modified in various manners including, for example, changing the size of a character, adding a comment, and adding a frame line to surround a block.

Furthermore, as shown in FIG. 16B, the display control unit 170 may perform control of displaying weights (w1 to wn) obtained for the morphemes when displaying a result of determination made for each of the blocks of the document data. The example in FIG. 16B shows that values of the weights are assigned to the respective morphemes including “LAWYER” and “COMPENSATION”. When the screen in FIG. 16B is displayed together with the screen in FIG. 16A, the user can easily understand which morpheme is a factor to determine the display mode. Note that the screen in FIG. 16A and the screen in FIG. 16B may be either arranged and displayed in one window, or displayed in different windows.

Furthermore, if a plurality of inference target data items are obtained as the document data to be inferred, the inference processing unit 160 may perform processing of: calculating, by the document data item, a score for each of the plurality of inference target data items; and outputting, by the block, the score for each of the plurality of blocks for inference target data items included in the plurality of inference target data items and having relatively high scores.

As described above, a plurality of blocks are assumed to be set for one document data item. Hence, if a score is calculated by the block for all the document data items, the processing load increases. However, if the document data items subjected to score calculation by the block are narrowed down in accordance with a score by the document, the processing load can be reduced. For example, the inference processing unit 160 may perform processing, of obtaining a score by the block, on a document data item whose score by the document data item is a predetermined threshold value or more. Alternatively, the inference processing unit 160 may perform processing, of obtaining a score by the block, on a predetermined number of document data items in descending order of score by the document data item. Alternatively, the inference processing unit 160 may perform processing, of obtaining a score by the block, on a document data item either having a score zone comparable to a score zone of a document that the user would like to know, or including a similar word.

### 3.6 Cross-Validation and Forecast Curve

As described above, the display control unit 170 calculates a score for each of the plurality of document data items subjected to classification processing, and performs display control based on the score. Specifically, the display control unit 170 may cause the display unit of the terminal device 20 to display a list of document data items sorted in descending order of score. The user of the terminal device 20, for example, selects any one or more of the document data items displayed in the list to check the details of the selected document data item, and determines whether the document data item is actually relevant to a given event. Hereinafter, the process of determining whether the document data is relevant to a given event is also referred to as a review.

Even if the user of the terminal device 20 reviews a plurality of document data items in descending order of score, there might be a case where no document data item relevant to a given event is found. In such a case, the user could be in doubt whether the document data item relevant to the given event is not actually included in the plurality of document data items, or whether the problem lies in the accuracy of the system.

Hence, the learning processing unit 140 of this embodiment may perform processing of obtaining a forecast curve in accordance with a result of cross validation. Here, the forecast curve is information indicating, when the review proceeds, transition in the number of discovered document data items determined to be relevant a given event. The forecast curve can show the user a prospective review result. For example, the forecast curve can allow the user to determine whether it is reasonable if a document data item relevant to a given event is not found by the review.

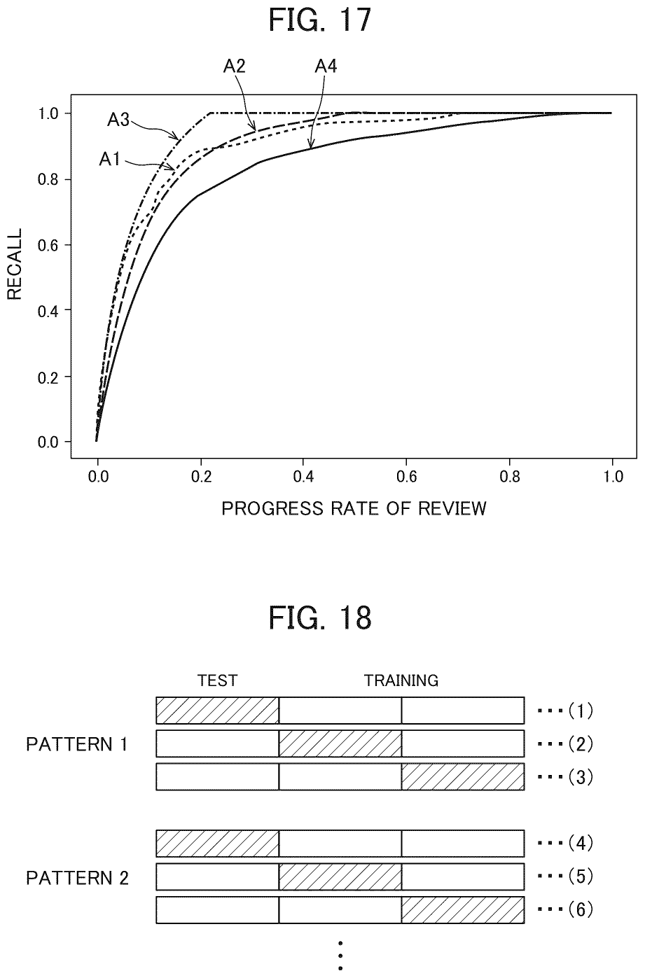

FIG. 17 illustrates exemplary forecast curves. The horizontal axis in FIG. 17 represents a progress rate of the review. That is, the horizontal axis represents a rate of reviewed document data items among document data items subjected to processing. The vertical axis represents a recall (a forecast recall). That is, the vertical axis in FIG. 17 represents a rate of document data items found (forecasted to be found) by the review among document data items relevant to a given event.

For example, considered is a case where: there are 1200 learning document data items; out of the learning document data items, 800 learning document data items are set as training data items to be used for machine learning; and the remaining 400 learning document data items are set as test data items to be used for validation of a learned model. Furthermore, considered here is an example where, out of the 400 test data items, 20 test data items are relevant to the given event, and the remaining 380 test data items are not relevant to the given event.

In this case, each of the 400 test data items is input into the learned model generated in accordance with the 800 training data items. Hence, a score of each test data item is calculated. Then, the 400 test data items are reviewed in descending order of score. Here, a correct answer data item is assigned to each test data item. Hence, the review is processing of determining whether each test data item is relevant to the given event in accordance with the correct answer data item. For example, when one document data item is reviewed, the value of the horizontal axis increases by 1/400. If the one document data item is relevant to the given event, the value of the vertical axis increases by 1/20. If the one document data is not relevant to the given event, the value of the vertical axis is maintained. This review is repeated until all the 400 document data items are completely reviewed, and a graph (a forecast line) is drawn in the coordinate system of FIG. 17. For example, A1 in FIG. 17 corresponds to the forecast line.

For example, assumed is a case where a set of coordinates (0.2, 0.9) are found on the forecast line. A value of 0.2 on the horizontal axis indicates that the document data items having the top 20% of the scores out of the 400 test data items; that is, the top 80 document data items, have been reviewed. A value of approximately 0.9 on the vertical axis indicates that, when the top 80 document data items are reviewed, only 20×0.9=18 document data items relevant to the given event have been found.

Note that, as A1 of FIG. 17 shows, the forecast line is not necessarily a smooth curve. For example, if there are not many documents relevant to the given event (e.g., 20 documents out of 400 documents in the above example), the forecast line is inevitably transformed into a stepwise line. This transformation into a stepwise line is probably due to a combination of the target training data items and test data items. Hence, the transformation could not be observed at a stage of the classification processing directed to different document data items. Hence, it is not preferable to show the user a forecast line including the stepwise transformation as the forecast curve.

Hence, in this embodiment, a plurality of combinations of training data items and test data items may be prepared, and a plurality of forecast lines obtained from the combinations may be averaged to obtain a forecast curve. Note that, in the cross validation, learning data is divided into N data items. Out of the N data items, N−1 data items are used as training data items, and the remaining 1 data item is used as a test data item. Hence, even normal N-fold cross validation can obtain N patterns of forecast lines. Note that, this embodiment may further increase the combination patterns of the data items to perform processing to obtain a more appropriate forecast curve.

For example, if a plurality of learning document data items are obtained as the document data, the learning processing unit 140 may sort the plurality of learning document data items to generate first to M-th (M is an integer of 2 or more) learning data items different from one another. Hence, the learning processing unit 140 performs the N-fold cross validation on each of the first to the M-th learning data items to obtain M×N patterns of evaluation data items.

FIG. 18 illustrates exemplary data patterns in processing of this embodiment. Here, three blocks arranged horizontally represent a result of the division by the N-fold cross validation. That is, FIG. 18 shows an example of performing three-fold cross validation. In FIG. 18, a shaded block is set as a test data item, and the remaining two blocks are set as training data items. Each block includes a plurality of document data items. For example, as described above, when the learning data includes 1200 document data items, each block includes 400 document data items.

In this case, when the 1200 document data items are sorted in an order defined by a pattern 1, the 1200 document data items are divided into three blocks of a 1st-to-400-th block, a 401-st-to-800-th block, and an 801-st-to-1200-th block. Hence, three learning data items are obtained. This corresponds to (1) to (3) of the pattern 1 in FIG. 18.

Furthermore, 1200 document data items are sorted in an order defined by a pattern 2 different from the pattern 1. The 1200 document data items are divided into three blocks of a 1st-to-400-th block, a 401-st-to-800-th block, and an 801-st-to-1200-th block. Hence, three learning data items are obtained. This corresponds to (4) to (6) of the pattern 2 in FIG. 18. Here, even in the same 1st-to-400-th block, the document data items are sorted in different orders between the pattern 1 and the pattern 2. Hence, the test data items of (1) and the test data items of (4) include different document data items. Likewise, the training data items of (1) and the training data items of (4) include different document data items. That is, even if the original learning data items are the same, the document data items are sorted in multiple order patterns and each cross-validated. Thanks to such a technique, various data items can be used for machine learning.

As described above, the document data items are sorted in M order patterns from the pattern 1 to the pattern M, and each of the document data items is N-fold cross-validated. Hence, machine learning can be performed in M×N patterns. Thus, for a result of each machine learning pattern, M×N patterns of evaluation data items can be obtained, using the test data items. Here, the evaluation data items may be, for example, the forecast line illustrated in FIG. 17. Note that the evaluation data items may be any given data. The evaluation data items may include other information such as a recall, an accuracy rate, a precision, and an AUC.

For example, when many forecast lines are obtained, statistical processing can be performed in accordance with the obtained forecast lines. For example, the learning processing unit 140 may generate forecast information at the learning stage, in accordance with a statistic using the M×N patterns of evaluation data items as a sample. Here, the forecast information is information for forecasting a result of a review, of document data items, conducted by the user in accordance with a score output from a learned model. The forecast information in a narrow sense is the forecast curve described above. Alternatively, the forecast information may be other information.

In this way, the learning processing unit 140 can obtain a smooth and highly accurate forecast curve in accordance with, for example, an average value of M×N forecast lines. For example, A2 in FIG. 17 represents a forecast curve obtained from an average value of a plurality of forecast lines.

Note that even with the normal N-fold cross validation, the larger the value of N is, the larger the number of forecast lines can be. However, the number of test data items decreases accordingly, which could result in a decrease in accuracy of processing performed using the test data items. There are N forecast lines, and the test data items account for 1/N of all the data items. Whereas, the smaller the value N is, the smaller the number of the forecast lines is. As a matter of fact, fewer training data items could lead to a decrease in accuracy of a learned model. The training data items account for (N−1)/N of all the data items. In this regard, when the technique of this embodiment increases the number M of the order patterns of the document data items, the number of evaluation data items increases. Hence, the technique does not have to set the value of N to an extreme value. For example, N can be set to a moderate value (e.g., approximately 3 to 5) in consideration of accuracy of a test and a learned model. For example, when M=20 holds, and even if N=3 holds, 20×3=60 patterns of data items can be obtained as evaluation data.

Note that, when obtaining the forecast information, the learning processing unit 140 does not have to use all of the M×N patterns of evaluation data items. For example, when N=3 holds as illustrated in FIG. 18, the training data items account for two-thirds of the total data items. Hence, the processing may be executed, factoring in influence of reduction in accuracy of the learned model. For example, the learning processing unit 140 may obtain forecast information in accordance with some of evaluation data items included in the M×N patterns of evaluation data items and having a learned model whose accuracy was evaluated relatively high, in order to correct the reduction in accuracy. As described above, when 60 patterns of evaluation data items are found, the learning processing unit 140 obtains the forecast information in accordance with evaluation data items at accuracy levels having a margin of a plus or minus Y-th accuracy level (2Y+1 patterns from an X−Y-th accuracy level to an X+Y-th accuracy level), mainly focusing on an evaluation data item at an X-th accuracy level. In this case, X is a value smaller than a median value (30 or 31), and may be, in a narrow sense, 1/4 or more (X≤15). Furthermore, the value Y can be changed in various manners. For example, the value Y may be set so that the lowest accuracy level (the X+Y-th accuracy level) used for processing is greater than, or equal to, the median value.

Moreover, the learning processing unit 140 may calculate variance and standard variation deviation from a plurality of forecast lines. For example, if the standard deviation is set to σ, the learning processing unit 140 may obtain 1.96σ above or below a forecast curve, obtained as the average value, as a confidence interval at the 95% level. In the example of FIG. 17, A3 represents a curve 1.96σ above, and A4 represents a curve 1.96σ below. An interval between A3 and A4 represents a confidence interval at the 95% level. For example, the learning processing unit 140 performs processing of storing, in the storage unit 200, the information represented by A2 to A3 in the graph of FIG. 17.

Furthermore, the learning processing unit 140 may determine, as an outlier, a data item outside a range of 3σ above or below, and remove the outlier from the processing. Removal of the outlier can improve accuracy in the processing.

The inference processing unit 160 may perform processing of outputting forecast information as information indicating a result of forecasting inference processing. For example, the inference processing unit 160 reads the graph shown in FIG. 17 from the storage unit 200, and causes the display control unit 170 to display the graph. In this way, the user of the terminal device 20 can view a forecast curve and a confidence interval. Hence, in the case where no document data relevant to a given event is found, the user can determine whether the case is a reasonable result.

Furthermore, if no document data item relevant to a given event is found even though a high score range is viewed, the display control unit 170 may perform processing of presenting information based on statistical processing. For example, the inference processing unit 160 may perform processing of obtaining a margin of error (MoE) in accordance with an equation (5) below. In the equation (5) below, p represents an assumed concentration; that is, a rate of forecasting document data items included in target document data items and relevant to a given event. For example, the learning processing unit 140 may estimate p at the stage of learning processing. The number of viewed documents indicates the number of document data items reviewed by the user. The number of viewed documents may be obtained from, for example, history of a review operation (e.g., an operation of selecting a document data item from a list) performed by the user on the terminal device 20.

$$\begin{matrix}[ Math . 5 ] & \\ MoE = 2 \times 1.96 \times \sqrt{\frac{p ( 1 - p )}{\begin{matrix}Number of Viewed \\ Documents\end{matrix}}} & ( 5 )\end{matrix}$$

For example, as a criterion of a limit of detection or below (i.e., the fact that no document data item relevant to a given event is found even though a high score range is viewed), the display control unit 170 may perform processing of presenting information indicating “not found at a concentration having an error of Z % at a confidence level of 95%” in accordance with the above equation (5). Here, Z represents the MoE in the above equation (5). For example, in a case where the assumed concentration is 0.01%, and where the user cannot find any document data items relevant to a given event even though he or she has reviewed 1000 document data items, the MoE obtained by the above equation (5) is 0.1. In this case, the display control unit 170 displays a message “Limit of Detection or Below=Not Found at a Concentration Having an Error of 0.1% at a Confidence Rate of 95%”. In this way, when no document data item relevant to a given event is found, this fact can be presented to the user with objective data in accordance with statistical processing.

Note that the technique of this embodiment shall not be limited to the one applied to the information processing device 10. The technique may be applied to a method, for processing information, executing the steps below. A method, for processing information, causes the information processing device 10 to perform steps of: obtaining a learned model generated by machine learning that involves: determining a weight of a morpheme in a model that is either a linear model or a generalized linear model, in accordance with a feature determined based on a result of morphological analysis of learning data that is learning document data; and deleting, from input data of the model, the feature corresponding to the morpheme having the weight determined to be smaller than, or equal to, a given threshold value; obtaining document data including an electronic mail transmitted and received by a monitored person; determining the feature to be input to the learned model in accordance with the result of the morphological analysis of the obtained document data; inputting the determined feature to the learned model, in order to calculate a score indicating a degree of relevance between the document data and a given event; and performing display control based on the score of the document data.

Note that this embodiment has been discussed so far in detail. A person skilled in the art will readily appreciate that many modifications are possible without substantially departing from the new matter and advantageous effects of the present embodiment. Accordingly, all such modifications are included in the scope of the present disclosure. For example, terms that appear at least once in the Specification or in the drawings along with another broader or synonymous terms can be replaced with the other broader or synonymous terms in any part of the Specification or the drawings. Moreover, all the combinations of this embodiment and the modifications are encompassed in the scope of the present disclosure. Furthermore, the configurations and operations of the information processing device, the terminal device, and the e-mail monitoring system, among others, are not limited to those described in this embodiment, and various modifications are possible.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing device, comprising:
a model obtaining unit configured to obtain a learned model generated by machine learning that involves: determining a weight of a morpheme in a model that is either a linear model or a generalized linear model, in accordance with a feature determined based on a result of morphological analysis of learning data that is learning document data; and deleting, from input data of the model, the feature corresponding to the morpheme having the weight determined to be smaller than, or equal to, a given threshold value;
an obtaining unit configured to obtain document data including an electronic mail transmitted and received by a monitored person;
a feature determining unit configured to determine the feature to be input to the learned model, in accordance with the result of the morphological analysis of the document data obtained by the obtaining unit;
an inference processing unit configured to input the feature, determined by the feature determining unit, to the learned model, in order to calculate a score indicating a degree of relevance between the document data and a given event; and
a display control unit configured to perform display control based on the score of the document data.

2. The information processing device according to claim 1, further comprising
a learning processing unit configured to perform the machine learning that involves: determining the weight of the morpheme in either the linear model or the generalized linear model, in accordance with the feature determined based on the result of the morphological analysis of the learning data; and deleting, from input data of the model, the feature corresponding to the morpheme having the weight determined to be smaller than, or equal to, a given threshold value,
wherein the model obtaining unit
obtains the learned model generated by the learning processing unit.

3. The information processing device according to claim 2,
wherein the learning processing unit
is switchable between ON and OFF of ensemble learning of obtaining, as the model, a plurality of models to be used in combination in inference processing; and
performs processing of evaluating the model, and, if performance of the model is determined to be lower than, or equal to, a predetermined level, turns OFF the ensemble learning, and continues the machine learning.

4. The information processing device according to claim 2,
wherein the feature determining unit
determines a metadata feature in accordance with metadata assigned to the document data, the metadata feature being a feature corresponding to the metadata, and
the learning processing unit
performs the machine learning in accordance with the feature corresponding to the morpheme and the metadata feature.

5. The information processing device according to claim 1,
wherein the inference processing unit performs processing of:
dividing the document data into a plurality of blocks in any given length; and outputting probability data for each of the plurality of blocks, the probability data being provided as the score and indicating a probability relevant to the given event.

6. The information processing device according to claim 5,
wherein the inference processing unit
compares, for each of the plurality of blocks, the score and a threshold value independent of a genre of the document data, and
the display control unit
controls a display mode of each block in accordance with a result of the comparison performed by the inference processing unit.

7. The information processing device according to claim 1,
wherein if a plurality of inference target data items are obtained as the document data to be inferred, the inference processing unit calculates the score for each of the plurality of inference target data items, and
the display control unit performs control to display a list including only inference target data items having relatively high scores among the plurality of inference target data items.

8. The information processing device according to claim 7,
wherein the display control unit
performs control to display the list in which the inference target data items included in the plurality of inference target data items and having the relatively high scores are sorted in descending order of the scores.

9. The information processing device according to claim 7,
wherein, when any one or more of document data items included in the document data are selected from the list, the display control unit performs control to display details of the any one or more selected document data items in a window separate from a window displaying the list.

10. A method, for processing information, causing an information processing device to perform processing of:
obtaining a learned model generated by machine learning that involves: determining a weight of a morpheme in a model that is either a linear model or a generalized linear model, in accordance with a feature determined based on a result of morphological analysis of learning data that is learning document data; and deleting, from input data of the model, the feature corresponding to the morpheme having the weight determined to be smaller than, or equal to, a given threshold value;
obtaining document data including an electronic mail transmitted and received by a monitored person;
determining the feature to be input to the learned model in accordance with the result of the morphological analysis of the obtained document data;
inputting the determined feature to the learned model, in order to calculate a score indicating a degree of relevance between the document data and a given event; and
performing display control based on the score of the document data.
